(19) United States
(12) Patent Application Publication
(10) Pub. No.: US 2015/0153483 A1
(43) Pub. Date: Jun. 4, 2015

(54) OPTICAL ELEMENT AND MANUFACTURING METHOD THEREOF, DISPLAY ELEMENT, AND PROJECTION IMAGE DISPLAY DEVICE

(71) Applicant: DEXERIALS CORPORATION, Tokyo (JP)

(72) Inventors: Sohmei Endoh, Utsunomiya-shi (JP); Ryosuke Murakami, Tokyo (JP)

(21) Appl. No.: 14/402,253

(22) PCT Filed: Jun. 6, 2013
(86) PCT No.: PCT/JP2013/065691

§ 371 Date: Nov. 19, 2014

(30) Foreign Application Priority Data
Jun. 8, 2012 (JP) 2012-130473

(51) Int. Cl. G02B 1/118; G02B 1/04; G02B 1/12; G02B 1/02

(52) U.S. Cl. CPC G02B 1/118; G02B 1/02; G02B 1/04; G02B 1/12

(57) ABSTRACT

An optical element, which has an antireflection performance offering excellent wavelength band characteristics and incident angle characteristics, includes a substrate and structures that each are formed of a convex portion and that are arranged in plural on a surface of the substrate at a fine pitch equal to or less than a wavelength of light. Each of the structures has a quadrangular pyramid shape or a truncated quadrangular pyramid shape that has a quadrangular bottom surface, and each of four sides that farm the quadrangular bottom surface is curved toward a center of the bottom surface.

### TECHNICAL FIELD

The present invention relates to an optical element and a manufacturing method thereof, a display element including the optical element, and a projection image display device. More specifically, the present invention relates to an optical element that has an antireflection function.

### BACKGROUND ART

In Patent Literature 1, at least one of optical surfaces of an optical element (a lens) is an aspheric surface. Then, an antireflection structure is configured so that at least part of a light ray effective portion of the aspheric surface includes a different component to a base material of the optical element, and such that the antireflection structure has a fine projecting and recessed structure with an average pitch of 400 nm or less. More specifically, the pitch of the fine projecting and recessed structure is set so that a refractive index becomes equivalent to that of a film, which changes gradually from air toward the base material, within a range of a used wavelength, and the optical element has an antireflection performance that excels in wavelength band characteristics and incidence angle characteristics.

Further, in Patent Literature 1, the fine projecting and recessed structure is formed of an inorganic substance (for example, aluminum or an aluminum oxide) that contains a different component from the optical element and that has excellent chemical durability. Therefore, the antireflection structure, which has the fine projecting and recessed structure, can not only suppress reflection at an interface of the optical element, but can also protect the base material of the optical element and prevent occurrence of burning or clouding.

Note that, as a method of forming the fine projecting and recessed structure having the average pitch of 400 nm or less, a method is used in which, using a sol-gel method, a solution containing an aluminum oxide is applied to a lens surface to form a coat and the coat is immersed in warm water of 40° C. or higher and 100° C. or lower to form the fine projecting and recessed structure. According to this method, it is possible to form an optical element surface relatively inexpensively, even if the optical element surface is an aspheric surface, etc. that has a large area and a large curvature.

### CITATION LIST

### Patent Literature

Patent Literature 1: Japanese Patent Application Laid-Open No. 2010-191074

### SUMMARY OF INVENTION

### Technical Problem

As described above, in recent years, an optical element is desired that has an antireflection performance having excellent wavelength band characteristics and incidence angle characteristics.

Therefore, an object of the present technique is to provide an optical element and a manufacturing method thereof which has an antireflection function having excellent wavelength band characteristics and incidence angle characteristics, a display element including the optical element, and a projection image display device.

### Solution to Problem

In order to solve the above-described problem, a first technique is an optical element that has an antireflection function, including

a substrate; and

structures that each are formed of a convex portion and that are arranged in plural on a surface of the substrate at a fine pitch equal to or less than a wavelength of light,

wherein each of the structures has one of a quadrangular pyramid shape and a truncated quadrangular pyramid shape that has a quadrangular bottom surface, and

each of four sides that form the quadrangular bottom surface is curved toward a center of the bottom surface.

A second technique is a manufacturing method of an optical element, which has an antireflection function, the method including: transferring a shape of a film master to an organic resin material to form structures that each are formed of a convex portion and that are arranged in plural on a surface of a substrate at a fine pitch equal to or less than a wavelength of light, wherein

each of the structures has one of a quadrangular pyramid shape and a truncated quadrangular pyramid shape that has a quadrangular bottom surface, and

each of four sides that form the quadrangular bottom surface is curved toward a center of the bottom surface.

With the present technique, as the plurality of structures, which are formed of the convex portions, are arranged on the surface of the substrate at the fine pitch equal to or less than the wavelength of light, it is possible to obtain the antireflection function excellent in wavelength band characteristics and incident angle characteristics.

### Advantageous Effects of Invention

As described above, according to the present technique, it is possible to provide an optical element that has an antireflection function having excellent wavelength band characteristics and incidence angle characteristics.

### BRIEF DESCRIPTION OF DRAWINGS

FIG. 1A is a plan view showing an example of a configuration of an optical element according to a first embodiment of the present technique. FIG. 1B is a plan view showing an enlarged portion of the optical element shown in FIG. 1A. FIG. 1C is a cross-sectional view thereof at tracks T1, T3, . . . shown in FIG. 1B.

FIG. 2 is a perspective view showing an example of a shape of a configuration of the optical element.

FIG. 3A is a perspective view of an example of a configuration of a film master. FIG. 3B is a plan view showing an enlarged portion of the film master shown in FIG. 3A. FIG. 3C is a cross-sectional view thereof at tracks T1, T3, . . . shown in FIG. 3A.

FIG. 4A is a perspective view of an example of a configuration of a roll master. FIG. 4B is a plan view showing an enlarged portion of the roll master shown in FIG. 4A. FIG. 4C is a cross-sectional view thereof at tracks T1, T3, . . . shown in FIG. 4A.

FIG. 5 is a schematic diagram showing an example of a configuration of a roll master exposure apparatus that is used to manufacture the roll master.

FIGS. 6A to 6D are process diagrams describing a manufacturing process of the optical element according to the first embodiment of the present technique.

FIGS. 7A to 7C are process diagrams describing the manufacturing process of the optical element according to the first embodiment of the present technique.

FIG. 8A and FIG. 8B are process diagrams describing the manufacturing process of the optical element according to the first embodiment of the present technique.

FIG. 9 is a plan view showing an example of a configuration of the optical element according to a first modified example.

FIG. 10A is a plan view showing an example of a configuration of the optical element according to a second modified example. FIG. 10B is a plan view showing an enlarged portion of the optical element shown in FIG. 10A. FIG. 10C is a cross-sectional view thereof at tracks T1, T3, shown in FIG. 10B.

FIG. 11A is a plan view showing an example of a configuration of the optical element according to a third modified example. FIG. 11B is a plan view showing an enlarged portion of the optical element shown in FIG. 11A.

FIG. 11C is a cross-sectional view thereof at tracks T1, T3, shown in FIG. 11B.

FIG. 12 is a perspective view showing an example of the shape of the structure of the optical element.

FIG. 13 is a diagram showing an example of a refractive index profile of the optical element according to a second embodiment of the present technique.

FIG. 14 is a cross-sectional view showing an example of the shape of the structure.

FIGS. 15A to 15C are diagrams describing a definition of a change point.

FIG. 16 is a cross-sectional view showing an example of the shape of the structure of the optical element according to a modified example.

FIG. 17 is a diagram showing an example of the refractive index profile of the optical element according to a third embodiment of the present technique.

FIG. 18 is an enlarged cross-sectional view showing an example of the shape of the structure.

FIGS. 19A to 19C are diagrams describing a definition of the change point.

FIG. 20 is a schematic diagram showing a configuration of a projection apparatus according to a fourth embodiment of the present technique.

FIG. 21 is a schematic diagram showing an enlarged view of a liquid crystal panel 112B shown in FIG. 20 and an area adjacent thereto.

FIG. 22 is a diagram showing reflection spectra of the optical elements according to Examples 1-1 to 1-3.

FIG. 23 is a diagram showing reflection spectra of the optical elements according to Comparative Examples 1-1 and 1-2.

FIG. 24 is a diagram showing transmission spectra of the optical elements according to Examples 2-1 to 2-5.

### DESCRIPTION OF EMBODIMENTS

Embodiments of the present technique will be described below with reference to the drawings in the following order.

1. First embodiment (a first example of an optical element)
2. Second embodiment (a second example of the optical element)
3. Third embodiment (a third example of the optical element)
4. Fourth embodiment (an example of a projection apparatus)

### 1. First Embodiment

### Configuration of Optical Element

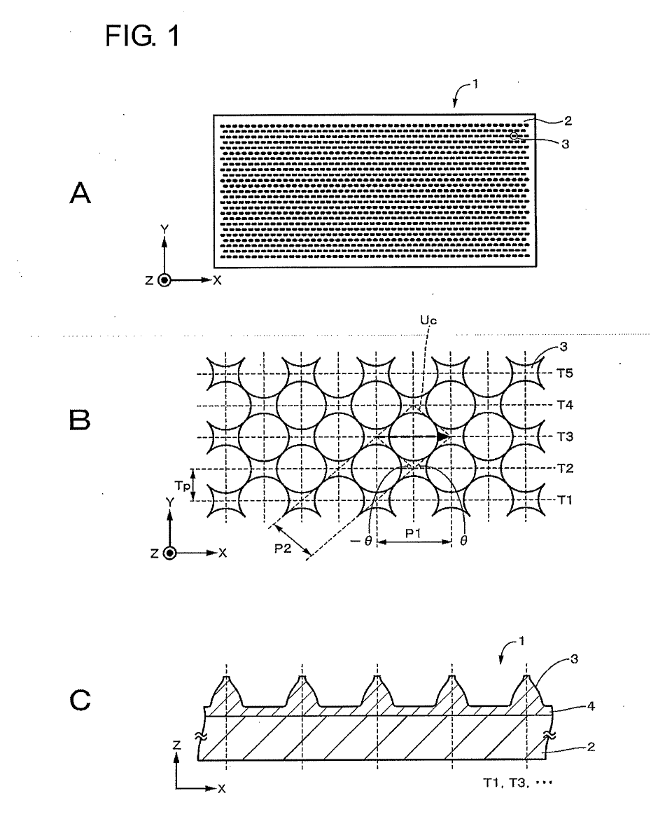

FIG. 1A is a plan view showing an example of a configuration of an optical element according to a first embodiment of the present technique. FIG. 1B is a plan view showing an enlarged portion of the optical element shown in FIG. 1A. FIG. 1C is a cross-sectional view thereof at tracks T1, T3, . . . shown in FIG. 1B. Here, two directions, which are orthogonal to each other within a principal surface of an optical element 1, are referred to as an X-axis direction and a Y-axis direction, respectively, and a direction that is perpendicular to the principal surface is referred to as a Z-axis direction.

The optical element 1 is suitable to be applied to various optical components that are used for electronic devices, optical communication (an optical fiber), solar batteries, lighting equipment, and the like. In terms of the electronic devices, the optical element 1 is particularly suitable to be applied to a projection apparatus (a projection image display device), more specifically, to a liquid crystal display element provided in the projection apparatus. The optical components can be a polarizing element, a lens, a light-guiding plate, a window material, a display element, etc. The polarizing element can be a polarizer, a reflective polarizer, and the like, for example.

The optical element 1 includes a substrate 2, which has the principal surface, and a plurality of structures 3 that are arranged on the principal surface of the substrate 2. The structures 3 and the substrate 2 are separately or integrally formed. When the structures 3 and the substrate 2 are separately formed, a basal layer 4 may be further provided between the structures 3 and the substrate 2, as necessary. The basal layer 4 is integrally formed with the structures 3 on a bottom surface side of the structures 3 and is formed by curing an energy ray curable resin composition, etc. that has the same composition as the structures 3. It is preferable that the optical element 1 have flexibility. This is because the flexibility makes it easier to apply the optical element 1 to a surface, such as a display surface, an input surface, and the like.

The substrate 2 that is provided in the optical element 1 and the structures 3 will be described below in order.

### (Substrate)

The substrate 2 is a substrate that has transparency, for example. For example, an organic material, such as a plastic material or the like, or an inorganic material, such as glass or the like, can be used as a material of the substrate 2. From the viewpoint of light resistance, it is preferable to use an inorganic material, such as glass.

For example, soda-lime glass, lead glass, hard glass, quartz glass, liquid crystalized glass and the like are used as the glass (refer to “Chemistry Handbook” Basic Edition, P. I-537, edited by the Chemistry Society of Japan). As the plastic material, from the viewpoints of optical characteristics, such as transparency, a refractive index, and dispersion, and of other characteristics, such as shock resistance, heat resistance, and durability, it is preferable to use (meta) acrylic resin, such as copolymers of polymethyl methacrylate or methyl methacrylate with vinyl monomers, which include other alkyl (meta) acrylates, styrene, and the like; polycarbonate resin, such as polycarbonate and diethylene glycol bisallyl carbonate (CR-39); thermosetting (meth)acrylic resin, such as (brominated) bisphenol A type di(meth)acrylate homopolymers or copolymers, and polymers or copolymers of (brominated) bisphenol A mono(meth)acrylate urethane-modified monomers: polyester, particularly, polyethylene terephthalate, polyethylene naphthalate, and unsaturated polyester; and acrylonitrile-styrene copolymers, polyvinyl chloride, polyurethane, epoxy resin, polyarylate, polyether sulfone, polyether ketone, cycloolefin polymers (product names: Arton and Zeonor), cycloolefin copolymers, and the like. Further, it is also possible to use heat-resistant aramid resins.

When a plastic material is used as the substrate 2, an undercoat layer may be provided as a surface treatment to further improve surface energy, coating properties, sliding properties, flatness, etc. of a plastic surface. As the undercoat layer, organoalkoxy metal compounds, polyester, acrylic-modified polyester, polyurethane, etc. can be used, for example. Alternatively, a corona discharge treatment or a UV irradiation treatment, etc. may be performed on the surface of the substrate 2 to obtain the same effect as a case in which the undercoat layer is provided.

When the substrate 2 is a plastic film, the substrate 2 can be obtained by such methods as stretching the above-described resin or diluting the resin in a solvent, forming the resin into a film-shape, and then drying the resin. Further, the thickness of the substrate 2 is approximately 25 μm to 500 μm, for example.

The shape of the substrate 2 can be a film-shape, a plate-shape, or a block-shape, but the shape of the substrate 2 is not particularly limited to those shapes. Here, it is defined that the film-shape includes a sheet-shape.

### (Structures)

The structure 3 has a convex shape with respect to the surface of the substrate 2. By forming the structure 3 into this type of shape, it is possible to improve antireflection characteristics of the structure 3 in comparison with a case in which the structure 3 has a concave shape with respect to the surface of the substrate 2. The plurality of structures 3 have an arrangement form in which a plurality of rows of tracks T1, T2, T3, . . . (hereinafter collectively referred to as “tracks T”) are formed on the surface of the substrate 2. In the present technique, a track refers to a section in which the structures 3 are continuously formed in a row. A linear shape, an arc shape, etc. can be used as a shape of the track T.

For example, the structures 3 are arranged between two of the tracks T, which are adjacent to each other, at positions displaced from the tracks T by a half pitch, respectively. More specifically, between two of the tracks T that are adjacent to each other, the structure 3 of one of the tracks (a track T2, for example) is arranged in an intermediate position (a position displaced by a half pitch) of the structure 3 that is arranged on another of the tracks (a track T1, for example). As a result, as shown in FIG. 1B, between three of the tracks (T1 to T3), which are adjacent to one another, the structures 3 are arranged so that centers of the structures 3 are positioned at respective points a1 to a4 that form a tetragonal lattice pattern or a quasi-tetragonal lattice pattern. Lower portions of the structures 3 arranged on the tracks T, which are adjacent to each other, do not have to be connected to each other in the ±θ directions, and the respective structures 3 may be independent from one another.

Here, the tetragonal lattice refers to a square-shaped lattice. The quasi-tetragonal lattice is different from the square-shaped lattice and refers to a deformed square-shaped lattice. For example, when the structures 3 are arranged on a straight line, the quasi-tetragonal lattice refers to a deformed square-shaped lattice that is formed as a result of stretching a square-shaped lattice in a linear arrangement direction (a track direction). When the structures 3 are arranged along a meandering line, the quasi-tetragonal lattice refers to a deformed tetragonal lattice, which is formed as a result of deforming a square-shaped lattice by a meandering arrangement of the structures 3, or a deformed tetragonal lattice, which is formed as a result of stretching a square-shaped lattice in the linear arrangement direction (the track direction) and then deforming the square-shaped lattice by the meandering arrangement of the structures 3.

It is preferable that an arrangement pitch P1 of the structures 3 in the same track be longer than an arrangement pitch P2 of the structures 3 between two of the tracks that are adjacent to each other. Further, it is preferable that a height or a depth of the structures 3 in the ±θ directions with respect to the tracks T be smaller than the height or the depth of the structures 3 in other directions. More specifically, it is preferable that the height or the depth of the structures 3 in ±45° directions or in approximately ±45° directions with respect to the tracks be smaller than the height or the depth of the structures 3 in an extending direction of the tracks.

It is preferable that a height H2 of the structures 3 in an arrangement direction (a θ direction) be smaller than a height H1 of the structures 3 in the extending direction of the tracks, the arrangement direction being diagonal with respect to the extending direction of the tracks. More specifically, it is preferable that the heights H1 and H2 of the structures 3 satisfy a relationship of H1>H2.

A filling rate of the structures 3 on the surface of the substrate has an upper limit of 100% and is within a range of 65% or more, preferably of 73% or more, and more preferably of 86% or more. It is possible to improve the antireflection characteristics by setting the filling rate to be within those ranges.

Here, the filling rate (an average filling rate) of the structures 3 is a value obtained in a manner described below.

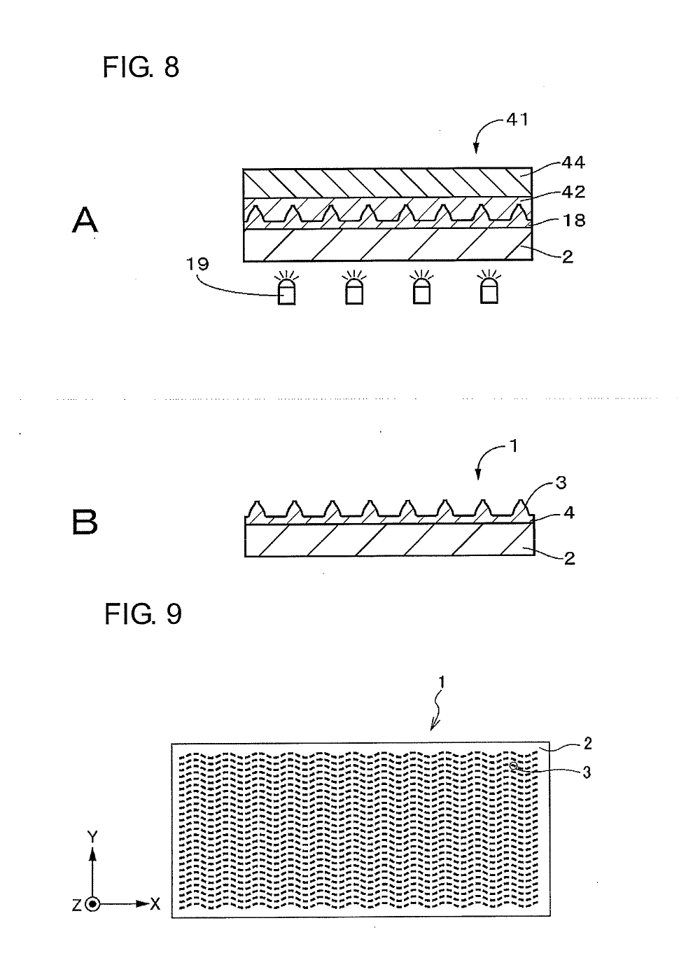

First, an image of a surface of the optical element 1 is captured in a Top View using a Scanning Electron Microscope (SEM). Next, of a captured SEM photo, a unit lattice Uc is randomly selected, and the arrangement pitch P1 of the unit lattice Uc and a track pitch Tp are measured (refer to FIG. 8B). Further, an area S of a bottom surface of one of the four structures 3, which are included in the unit lattice Uc, is measured by image processing. Next, the filling rate is obtained using Formula (4) described below using the measured arrangement pitch P1, the track pitch Tp, and the area S of the bottom surface.

Filling rate=(S (tetra)/S (unit))×100

Unit lattice area: S (unit)=2×((P1×Tp)×(1/2))=P1×Tp

Area of bottom surface of structure existing inside unit lattice: S (tetra)=S (4)

The above-described filling rate calculation processing is performed with respect to the unit lattices arranged at ten locations that are randomly selected from the captured SEM photo. Then, an average rate of the filling rate is obtained by simply averaging (arithmetically averaging) measurement values, and the average rate is set as the filling rate of the structures 3 on the surface of the substrate.

The structure 3 has a quadrangular bottom surface, and four sides, which form the quadrangular shape, are curved toward a center of the quadrangular shape. The shape of the curved four sides can be an arc-shape, an approximate arc-shape, an elliptic arc-shape, or an approximate elliptic arc-shape, for example. Here, the approximate arc-shape refers to a shape obtained by slightly deforming an arithmetically-defined perfect arc-shape. The approximate elliptic arc-shape refers to a shape obtained by slightly deforming an arithmetically-defined perfect elliptic arc-shape.

The quadrangular shape, which is a shape of the bottom surface of the structure 3, can be a quadrangular shape having four sides of an approximately equal length, a quadrangular shape having a pair of long sides opposing each other and a pair of short sides opposing each other, etc., for example. When a roll master is manufactured using a roll master exposure apparatus (refer to FIG. 5), which will be described below, it is preferable that, when the shape of the bottom surface of the structure 3 is the quadrangular shape having the long sides and the short sides, the long sides be parallel to the tracks. This is because the manufacture of the structures 3 is made easier in this manner.

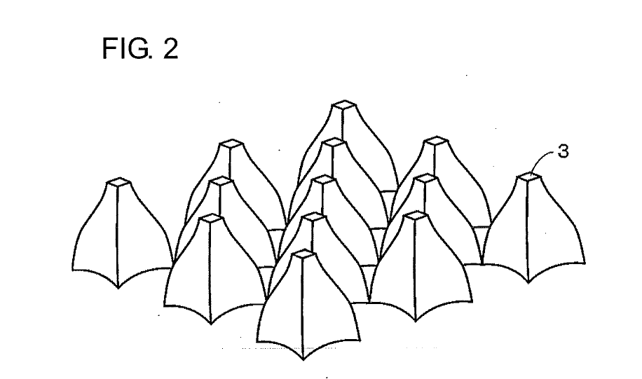

As shown in FIG. 2, the shape of the structure 3 having the quadrangular bottom surface may be a cone-shape, such as a quadrangular pyramid and a truncated quadrangular pyramid, for example. The cone-shape can be a cone-shape having a pointed top portion, a cone-shape having a flat top portion, a cone-shape having a convexly or concavely curved surface as a top portion thereof, for example, but the cone-shape is not limited to those shapes. The cone-shape having the convexly curved surface can be a shape of a quadric surface, etc., such as a paraboloidal shape. Further, conical surfaces of the cone-shape may be convexly and/or concavely curved.

It is preferable that the structure 3 have a curved surface portion, a height of which gently decreases in a direction from a top portion toward a lower portion thereof, on a peripheral portion of a bottom portion thereof. In this manner, it becomes possible to separate the optical element 1 from a master, etc. in a manufacturing process of the optical element 1. Note that, although the curved surface portion may be provided only on part of the peripheral portion of the structure 3, it is preferable that the curved surface portion be provided on the entire peripheral portion of the structure 3 from the viewpoint of improving the above-described separation characteristics.

It is preferable to provide a protruding portion on part or an entirety of a periphery of the structure 3. By doing so, even when the filling rate of the structures 3 is low, it is possible to suppress reflectance to a low level. It is preferable to provide the protruding portion at a position between the structures 3, which are adjacent to each other, from the viewpoint of ease of forming the protruding portion. Further, a long and thin protruding portion may be provided on the part or the entirety of the periphery of the structure 3. The long and thin protruding portion can be extended in the direction from the top portion of the structure 3 toward the lower portion thereof, for example, but the long and thin protruding portion is not particularly limited to this form. The shape of the protruding portion can be formed to have a triangular cross-sectional shape, a quadrangular cross-sectional shape, etc., but the shape of the protruding portion is not particularly limited to those shapes and can be selected in consideration of the ease of forming, etc. Further, a surface of the part or the entirety of the periphery of the structure 3 may be roughened so that fine concavities and convexities are formed on the surface. More specifically, a surface positioned between the structures 3, which are adjacent to each other, may be roughened so that the fine concavities and convexities are formed on the surface, for example. Further, a minute hole may be formed in the surface of the structure 3, for example, on the top portion thereof.

Note that, although each of the structures 3 has the same size, shape, and height in FIG. 2, the shape of the structure 3 is not limited to this, and the structures 3 having two or more types of size, shape, and height may be formed on the surface of the substrate.

The structures 3 are two-dimensionally arranged regularly (periodically) at a short arrangement pitch, which is equal to or smaller than a wavelength band of light that is intended to reduce reflection. By two-dimensionally arranging the plurality of structures 3 in this manner, a two-dimensional wave surface may be formed on the surface of the substrate 2. Here, the arrangement pitch refers to the arrangement pitch P1 and the arrangement pitch P2. The wavelength band of light that is intended to reduce reflection is a wavelength band of ultraviolet light, a wavelength band of visible light, or a wavelength band of infrared light, for example. Here, the wavelength band of ultraviolet light refers to a wavelength band of between 10 nm and 360 nm, the wavelength band of visible light refers to a wavelength band of between 360 nm and 830 nm, and the wavelength band of infrared light is a wavelength band of between 830 nm and 1 mm. More specifically, it is preferable that the arrangement pitch be 175 nm or larger and 350 nm or smaller. When the arrangement pitch is smaller than 175 nm, there is a tendency that the manufacture of the structures 3 becomes difficult. On the other hand, when the arrangement pitch exceeds 350 nm, there is a tendency that diffraction of visible light occurs.

The height of the structure 3 is not particularly limited and is set appropriately according to a wavelength range of light to be transmitted. For example, the height of the structure 3 is set within a range of 236 nm or more and 450 nm or less and preferably within a range of 415 nm or more and 421 nm or less.

An aspect ratio of the structure 3 (the height H/the arrangement pitch P) is preferably within a range of 0.6 or more and 5 or less, more preferably of 0.6 or more and 4 or less, and most preferably of 0.6 or more and 1.5 or less. When the aspect ratio is less than 0.6, there is a tendency that reflection characteristics and transmission characteristics deteriorate. On the other hand, when the aspect ratio exceeds 5, there is a tendency that transferability deteriorates even when processing is performed by applying a fluorine coating to the master or adding an additive, such as a silicon additive or a fluorine additive, to a transfer resin, for example, to improve the separation characteristics. Further, when the aspect ratio exceeds 4, as there is no major change in luminous reflectance, it is preferable to set the aspect ratio of 4 or less from both the viewpoints of improving the luminous reflectance and of ease of separation. When the aspect ratio exceeds 1.5, as described above, there is a tendency that the transferability deteriorates when the processing that improves the separation characteristics is not performed.

Further, from the viewpoint of further improving the reflection characteristics, it is preferable to set the aspect ratio of the structure 3 within a range of 0.94 or more and 1.46 or less. Further, from the viewpoint of further improving the transmission characteristics, it is preferable to set the aspect ratio of the structure 3 within a range of 0.81 or more and 1.28 or less.

Note that all the aspect ratios of the structures 3 do not necessarily have to be the same, but the respective structures 3 may be formed so as to have a constant height distribution (the aspect ratio being approximately within a range of between 0.83 and 1.46, for example). By providing the structures 3 that have the height distribution, it is possible to reduce wavelength dependence of the reflection characteristics. Hence, it is possible to realize the optical element 1 that has excellent antireflection characteristics.

Here, the height distribution refers to the fact that the structures 3 having two or more types of height are provided on the surface of the substrate 2. For example, the structures 3 having a standard height and the structures 3 having a height different from the standard height may be provided on the surface of the substrate 2. In this case, the structures 3 having the different height from the standard height are periodically or non-periodically (randomly) provided on the surface of the substrate 2, for example. A direction of the periodicity can be the extending direction or a row direction of the tracks, for example.

Note that, in the pi′esent technique, the aspect ratio is defined by the following formula (1).

Aspect ratio=H/P (1)

Note that H: a height of the structure and P: an average arrangement pitch (average period).

Here, the average arrangement pitch P is defined by the following formula (2).

Average arrangement pitch P=(P1+P2+P2)/3 (2)

Note that P1: an arrangement pitch in the extending direction of the tracks (a track extending direction period) and P2: an arrangement pitch in the ±0 directions with respect to the extending direction of the tracks (θ=45°−δ, and here, δ is preferably 0°<δ≦11° and more preferably 3°≦δ≦6° (a θ direction period).

### [Configuration of Film Master]

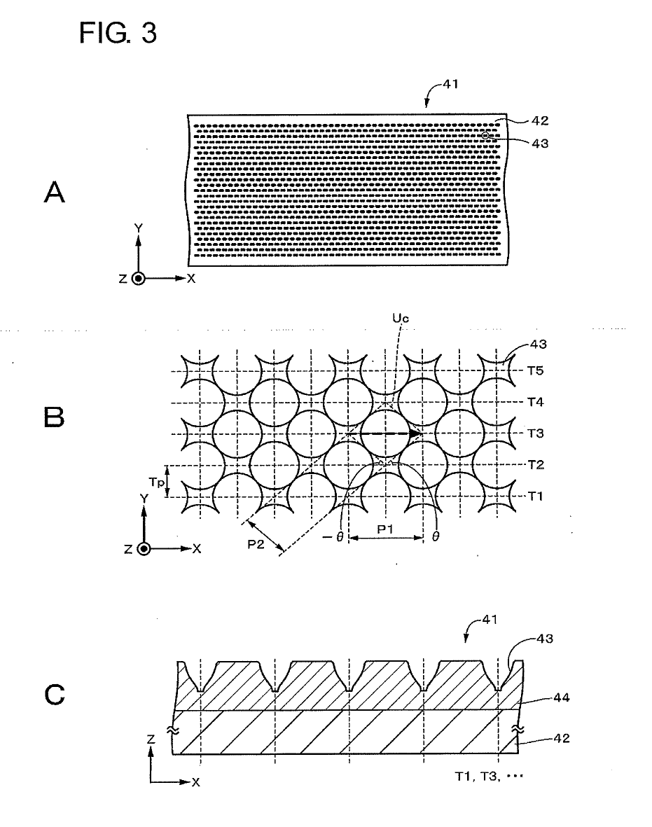

FIG. 3A is a perspective view showing an example of a configuration of a film master. FIG. 3B is a plan view showing an enlarged portion of the film master shown in FIG. 3A. FIG. 3C is a cross-sectional view thereof at tracks T1, T3, . . . shown in FIG. 3A. Here, two directions, which are orthogonal to each other within a principal surface of a film master 41, are referred to as an X-axis direction and a Y-axis direction, respectively, and a direction that is perpendicular to the principal surface is referred to as a Z-axis direction.

The film master 41 is a film-shaped master that forms the plurality of structures 3 on the surface of the substrate of the above-described optical element 1. The film master 41 has a quadrangular shape, for example, when viewed from a side of the Z-axis direction that is perpendicular to the principal surface. One of the principal surfaces of the film master is a forming surface that is to form the plurality of structures 3 on the surface of the substrate of the optical element 1. A plurality of structures 43 are two-dimensionally arranged on the forming surface. The structure 43 has a concave shape with respect to the forming surface, for example.

The film master 41 includes a substrate 42, which has the principal surface, and a shaped layer 44, which is provided on the principal surface of the substrate 42. The plurality of structures 43 are provided on a surface of the shaped layer 44. The configuration of the film master 41 is not limited to a two-layered structure in which the substrate 42 and the shaped layer 44 are laminated together, but the configuration of the film master 41 can be a single-layer structure, in which the substrate 42 and the shaped layer 44 are integrally formed, or a multi-layered structure that has three or more layers by having an adhesive layer or the like between the substrate 42 and the shaped layer 44.

For example, the shaped layer 44 is formed by curing an energy ray curable resin composition, etc. that is the same composition as the structures 3 of the optical element 1. It is preferable that the film master 41 have flexibility. This is because the flexibility makes it easier to separate the film master 41 in a transfer process.

The plurality of structures 43 arranged on the forming surface of the film master 41 and the plurality of structures 3 arranged on the surface of the substrate 2 of the above-described optical element 1 have an inverted concave and convex relationship.

### [Configuration of Roll Master]

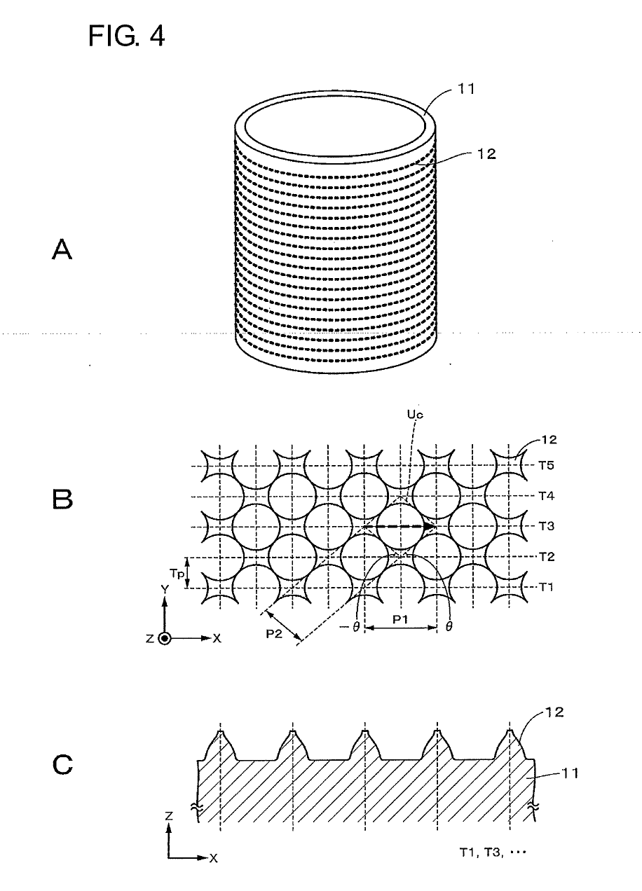

FIG. 4A is a perspective view showing an example of a configuration of a roll master. FIG. 4B is a plan view showing an enlarged portion of the roll master shown in FIG. 4A. FIG. 4C is a cross-sectional view thereof at tracks T1, T3, . . . shown in FIG. 4A. A roll master 11 is a master that forms the plurality of structures 43 on the surface of the above-described film master. The roll master 11 has a cylindrical shape or a column-shape, for example, and a cylindrical surface or a column surface thereof is formed as a forming surface that is to form the plurality of structures 43 on the surface of the substrate of the film master 41. A plurality of structures 12 are two-dimensionally arranged on the forming surface. The structure 12 has a convex shape with respect to the forming surface. Glass can be used as a material of the roll master 11, for example, but the material of the roll master 11 is not particularly limited to this material.

The configuration of the plurality of structures 12 arranged on the forming surface of the roll master 11 is the same as that of the plurality of structures 3 arranged on the surface of the above-described substrate 2. More specifically, a shape, an arrangement, and an arrangement pitch of the structures 12 of the roll master 11 are the same as those of the structures 3 of the substrate 2.

The plurality of structures 12 arranged on the forming surface of the roll master 11 and the plurality of structures 43 arranged on the forming surface of the above-described film master 41 have an inverted concave and convex relationship.

### [Configuration of Exposure Apparatus]

FIG. 5 is a schematic diagram showing an example of a configuration of a roll master exposure apparatus that manufactures the roll master. This roll master exposure apparatus is formed on the basis of an optical disk recording apparatus.

A laser beam source 21 is a light source that causes a resist, which is deposited on a surface of the roll master 11 serving as a recoding medium, to be exposed with light. The laser beam source 21 emits a laser beam 14 for recording at a wavelength of λ=266 nm, for example. The laser beam 14, which is emitted from the laser beam source 21, travels in a straight line remaining as a parallel beam and enters into an Electro Optical element (EOM: Electro Optical Modulator) 22. The laser beam 14, which is transmitted through the EOM 22, is reflected by a mirror 23 and is guided to a modulation optical system 25.

The mirror 23 is formed by a polarizing beam splitter and has a function of reflecting one polarization component and causing another polarization component to be transmitted therethrough. The polarization component, which is transmitted through the mirror 23, is received by a photodiode 24, and, based on the light-receiving signal, the EOM 22 is controlled to perform phase modulation of the laser beam 14.

In the modulation optical system 25, the laser beam 14 is condensed by a condensing lens 26 to an Acousto-Optic element (AOM: Acousto-Optic Modulator) 27, which is formed by glass (SiO₂), etc. After the laser beam 14 is intensity-modulated and diverged by the AOM 27, the laser beam 14 is turned into a parallel beam by a lens 28. The laser beam 14 emitted from the modulation optical system 25 is reflected by a mirror 31 and guided onto a moving optical table 32 while being horizontal and parallel thereto.

The moving optical table 32 includes a beam expander 33 and an objective lens 34. After the laser beam 14, which is guided by the moving optical table 32, is formed into a desired beam shape by the beam expander 33, the laser beam 14 is irradiated onto a resist layer on the roll master 11 via the objective lens 34. The roll master 11 is placed on a turntable 36 that is connected to a spindle motor 35. Then, an exposure process of the resist layer is performed by intermittently irradiating the laser beam 14 onto the resist layer while causing the roll master 11 to rotate and moving the laser beam 14 in a height direction of the roll master 11. A formed latent image is an approximately elliptic shape having a long axis thereof in a circumferential direction. The movement of the laser beam 14 is performed by moving the moving optical table 32 in an arrow R direction.

The exposure apparatus includes a control mechanism 37 that is used to form, on the resist layer, a latent image corresponding to the two-dimensional tetragonal lattice or quasi-tetragonal lattice pattern shown in FIG. 1B. The control mechanism 37 includes a formatter 29 and a driver 30. The formatter 29 includes a polarity reversing portion, and the polarity reversing portion controls an irradiation timing of the laser beam 14 onto the resist layer. The driver 30 controls the AOM 27 in response to an output from the polarity reversing portion.

In this roll master exposure apparatus, a signal is generated by synchronizing a polarity reversing formatter signal with a rotation controller for each of the tracks so that the two-dimensional patterns are linked to one another spatially, and the signal is intensity-modulated by the AOM 27. The tetragonal lattice pattern or the quasi-tetragonal lattice pattern can be recorded by performing patterning at a constant angular velocity (CAV) using an appropriate rotation frequency, an appropriate modulation frequency, and an appropriate feed pitch.

### [Manufacturing Method of Optical Element]

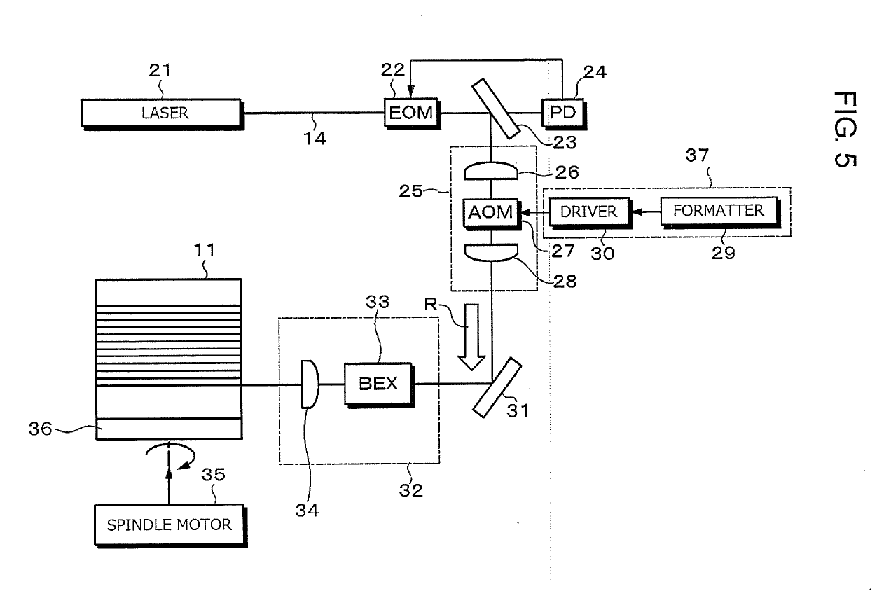

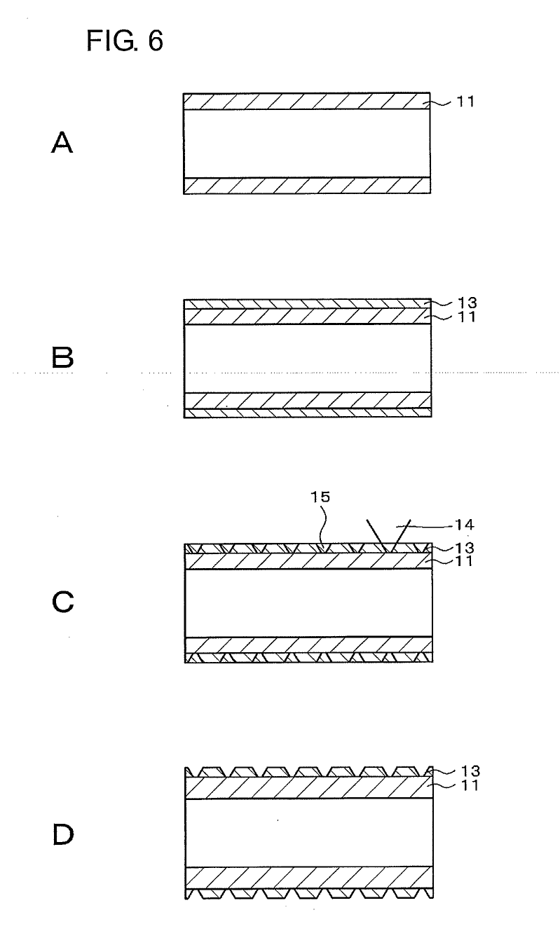

Next, a manufacturing method of the optical element 1 according to the first embodiment of the present technique will be described with reference to FIGS. 6A to 8B. Note that, in this manufacturing method of the optical element 1, a method that combines an optical disk master manufacturing process and an etching process is used as a roll master manufacturing method.

### [Resist Film Forming Process]

First, as shown in FIG. 6A, the roll master 11 of a column or cylindrical shape is prepared. The roll master 11 is a glass master, for example. Next, as shown in FIG. 6B, a resist layer 13 is formed on the surface of the roll master 11. Either an organic resist or an inorganic resist may be used as a material of the resist layer 13, for example. A novolac resist or a chemically-amplified resist can be used as the organic resist, for example. Further, a metal compound, which contains one or more types of metal, can be used as the inorganic resist, for example.

### [Exposure Process]

Next, as shown in FIG. 6C, the laser beam (exposure beam) 14 is irradiated onto the resist layer 13 that is formed on the surface of the roll master 11. More specifically, while the roll master 11 is placed on the turntable 36 of the roll master exposure apparatus shown in FIG. 5 and is rotated thereon, the laser beam (exposure beam) 14 is irradiated onto the resist layer 13. At this time, an entire surface of the resist layer 13 is exposed by intermittently irradiating the laser beam 14 thereon while moving the laser beam 14 in the height direction of the roll master 11 (in a direction parallel to a central axis of the column-shaped or cylindrical roll master 11). In this manner, a latent image 15 corresponding to a trajectory of the laser beam 14 is formed over the entire surface of the resist layer 13, for example, at a pitch similar to a visible light wavelength.

The latent image 15 is arranged so as to form a plurality of rows of tracks on the surface of the roll master, for example, and forms a tetragonal lattice pattern or a quasi-tetragonal lattice pattern on the surface. The latent image 15 is an elliptic shape having a long axis direction thereof in the extending direction of the tracks, for example.

### [Development Process]

Next, development processing is performed on the resist layer 13 by dripping a liquid developer on the resist layer 13 while rotating the roll master 11, for example. In this manner, as shown in FIG. 6D, a plurality of openings are formed in the resist layer 13. When the resist layer 13 is formed of a positive resist, a dissolution rate for the liquid developer increases in an exposure portion, which is exposed by the laser beam 14 when compared with that of a non-exposure portion. Accordingly, a pattern corresponding to the latent image (exposure portion) 15 is formed on the resist layer 13 as shown in FIG. 6D. A pattern of the openings is a predetermined lattice pattern, such as a tetragonal lattice pattern or a quasi-tetragonal lattice pattern, for example.

### [Etching Process]

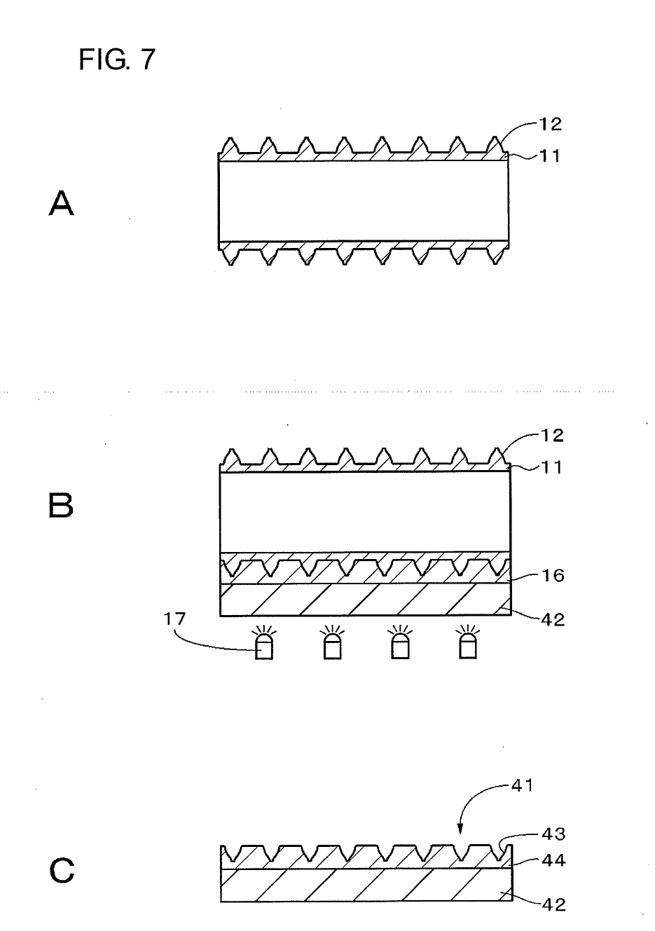

Next, etching processing is performed on the surface of the roll master 11 using the pattern of the resist layer 13 (a resist pattern), which is formed on the roll master 11, as a mask. In this manner, as shown in FIG. 7A, the structures 12 can be obtained that are each an elliptic cone-shaped or a truncated elliptic cone-shaped concave portion that has a long axis direction thereof in the extending direction of the tracks. Dry etching or wet etching can be used as the etching, for example. At this time, by alternately performing the etching processing and ashing processing, for example, a pattern of the cone-shaped structures 12 can be formed.

In the above-described manner, the intended roll master 11 is obtained.

### [Film Master Manufacturing Process]

Next, as shown in FIG. 7B, a transfer material 16 is cured by irradiating an energy ray, such as an ultraviolet ray, from an energy ray source 17 onto the transfer material 16, while rotating the roll master 11 and bringing the roll master 11 and the transfer material 16, which is applied on the substrate 42, into close contact to each other. Next, while maintaining the rotation of the roll master 11, the substrate 42, which is integrated with the cured transfer material 16, is separated from the forming surface of the roll master 11, whereby the shaped layer 44, on which the plurality of structures 43 each having a concave shape are provided, is formed on the surface of the substrate. In this manner, as shown in FIG. 7C, the film master 41 is obtained. It is preferable that this film master manufacturing process be a roll-to-roll process. This is because it is possible to improve productivity in this manner.

The energy ray source 17 is not particularly limited to a particular source as long as the source can emit an energy ray, such as an electron beam, an ultraviolet ray, an infrared ray, a laser beam, a visible light beam, an ionizing radiation (X rays, α-rays, β-rays, γ-rays, etc.) a microwave, or a high frequency wave.

It is preferable that an energy ray curable resin composition be used as the transfer material 16. It is preferable that an ultraviolet ray-curable resin composition be used as the energy ray curable resin composition. The energy ray curable resin composition may include a filler, a functional additive, etc. as necessary.

It is preferable that the energy ray curable resin composition include silicone acrylate, urethane acrylate, and an initiator. Silicone acrylate that has two or more acrylate polymerizable unsaturated groups on a side chain, a terminal, or both in one molecule can be used as the silicone acrylate. One or more types of (meth)acryloyl groups and (meth)acryloyloxy groups can be used as acrylate polymerizable unsaturated groups. Further, the (meth)acryloyl group herein refers to an acryloyl group and a methacryloyl group.

The silicone acrylate and methacrylate can be polydimethylsiloxane that has an organic modified acrylic group, for example. The organic modification can be a polyether modification, a polyester modification, an alkyl modification, or a polyether/polyester modification, for example. Specific examples may include Silaplane FM7725 manufactured by Chisso Corporation, EB350 and EB1360 manufactured by Daicel-cytec Co., Ltd., and EGORad 2100, TEGORad 2200 N, TEGORad 2250, TEGORad 2300, TEGORad 2500, and TEGORad 2700 manufactured by Degussa Corporation.

Urethane acrylate that has two or more acrylate polymerizable unsaturated groups on a side chain, a terminal, or both in one molecule, can be used as the urethane acrylate. One or more types of (meth)acryloyl groups and (meth)acryloyloxy groups can be used as the acrylate polymerizable unsaturated groups. Further, the (meth)acryloyl group herein refers to an acryloyl group and a methacryloyl group.

As the urethane acrylate, for example, urethane acrylate, urethane methacrylate, aliphatic urethane acrylate, aliphatic urethane methacrylate, aromatic urethane acrylate, and aromatic urethane methacrylate can be used. For example, functional urethane acrylate oligomer CN series CN980, CN965, CN962, etc., which are manufactured by Sartomer Corporation, can be used.

As the initiator, for example, 2,2-dimethoxy-1,2-diphenylethane-1-on, 1-hydroxy-cyclohexylphenylketone, 2-hydroxyl-2-methyl-1-phenylpropane-1-on, etc. can be used.

As the filler, for example, either an inorganic particle or an organic particle can be used. As the inorganic particle, metal oxide particles, such as SiO₂, TiO₂, ZrO₂, SnO₂, and Al₂O₃ can be used, for example.

The functional additive can be a leveling agent, a surface conditioner, an antifoaming agent, etc., for example. The material of the substrate 2 can be a methyl methacrylate (co)polymer, polycarbonate, a styrene (co)polymer, a methyl methacrylate-styrene copolymer, cellulose diacetate, cellulose triacetate, cellulose acetate butyrate, polyester, polyamide, polyimide, polyether sulfone, polysulfone, polypropylene, polymethylpentene, polyvinyl chloride, polyvinyl acetal, polyether ketone, polyurethane, glass, etc.

A forming method of the substrate 42 is not particularly limited to a particular method, and the substrate 42 may be an injection-molded body, an extrusion-molded body, or a cast-molded body. A surface treatment, such as a corona treatment, may be performed to the surface of the substrate as necessary.

Note that, when the structure 43 with a high aspect ratio (for example the structures 43 with the aspect ratio of greater than 1.5 and 5 or less) is manufactured, it is preferable that a parting agent, such as a silicon parting agent or a fluorine parting agent, be applied to the surface of the roll master 11 to improve release characteristics of the roll master 11. Further, it is preferable to add an additive, such as a fluorine additive or a silicon additive, to the transfer material 16.

### [Cutting-Out Process]

Next, the obtained film master 41 may be cut out into a predetermined size, as necessary.

### [Optical Element Manufacturing Process]

Next, as shown in FIG. 8A, a transfer material 18 is cured by irradiating an energy ray, such as an ultraviolet ray, from an energy ray source 19 onto the transfer material 18, while bringing the film master 41 and the transfer material 18, which is applied on the substrate 2, into close contact with each other. Next, the substrate 2, which is integrated with the cured transfer material 18, is separated from the film master 41, whereby the plurality of structures 3 each having a convex shape are formed on the surface of the substrate 2. In this manner, as shown in FIG. 8B, the optical element 1 is obtained.

As the transfer material 18 and the energy ray source 19, the same materials and sources as those used for the transfer material 16 and the energy ray source 17 in the above-described film master manufacturing process can be used. However, it is preferable to use a light-resistant organic material as the transfer material 18. As the light-resistant organic material, it is preferable to use a light-resistant organic material having an absorptance within a range indicated below after being cured (more specifically, after the structures are formed). More specifically, the absorptance of the cured transfer material 18, more specifically, the absorptance of the structures 3, to light with a wavelength of 424 nm or more and 750 nm or less cis preferably within a range of 4% or less, more preferably of 2.35% or less, and even more preferably of 1.2% or less. Note that the range of the absorptance of this kind can be adjusted by selecting types of the initiator.

A forming method of the substrate 2 is not particularly limited to a particular method, and the substrate 2 may be an injection-molded body, an extrusion-molded body, or a cast-molded body. A surface treatment, such as a corona treatment, may be performed to the surface of the substrate as necessary.

Note that, when the structures 3 with a high aspect ratio (for example the structures 3 with the aspect ratio of greater than 1.5 and 5 or less) is manufactured, it is preferable that a parting agent, such as a silicon parting agent or a fluorine parting agent, be applied to the surface of the film master 41 to improve release characteristics of the film master 41. Further, it is preferable to add an additive, such as a fluorine additive or a silicon additive, to the transfer material 18.

### [Cutting Out Process]

Next, the obtained optical element 1 may be cut out into a predetermined size as necessary.

According to the first embodiment, as the structure 3 is formed in a convex shape with respect to the surface of the substrate 2, it is possible to improve the antireflection characteristics when compared with a case in which the structure 3 is formed in a concave shape with respect to the surface of the substrate 2. Further, as the bottom surface of the structure 3 is formed in a quadrangular shape and also the four sides, which form the quadrangular shape, are curved toward the center of the quadrangular shape, it is possible to easily manufacture the roll master 11 using the method that combines the master manufacturing process and etching process for an optical disk. Hence, it is possible to efficiently manufacture the roll master 11 in a short period of time.

In the technique described in Patent Literature 1, as the aluminum oxide, which is used for the sol-gel method, is an expensive material, and also, as it is difficult to manufacture the optical element in a short period of time using the sol-gel method, there is a limit to manufacture the optical element inexpensively, and also, there is a problem in terms of mass productivity. Further, as the refractive index of the aluminum oxide is very high at 1.76, when a material, which has a relatively low refractive index (1.50 or less, for example), is used as the substrate, there is also a problem in terms of interface reflection.

In contrast, in the first embodiment of the present technique, when a nano imprint transfer is performed by using the film master (Motheye-Film master) that is manufactured by the roll-to-roll process, the transfer material 18 that is a light-resistant organic material, and the heat-resistant substrate 2, it is possible to manufacture an optical element, which has excellent in light-resistant and heat-resistant characteristics, very inexpensively in a process that offers excellent mass productivity. Further, when the light-resistant organic material is used as the transfer material 18, it is possible to prevent interface reflection between the substrate 2 and the structures 3.

### Modified Examples

### First Modified Example

As shown in FIG. 9, the tracks T may be made to wobble (meander). By making the tracks T wobble in this manner, it is possible to prevent unevenness in appearance from occurring. Note that only part of the tracks T on the surface of the optical element may be made to wobble. Although an example is shown in FIG. 9 in which the straight track T is made to wobble, a shape of the track T is not limited thereto. For example, the track T that has an arc-shape, etc. may be made to wobble.

When the track T is made to wobble, it is preferable that the wobble of the tracks T on the substrate 2 be synchronized with each other. More specifically, it is preferable that the wobble be a synchronized wobble. By synchronizing the wobble in this manner, it is possible to maintain a unit lattice shape of a tetragonal lattice or a quasi-tetragonal lattice and to keep the filling rate high. A waveform of the wobbled track T can be a sine wave, a triangular wave, etc., for example. The waveform of the wobbled track T is not limited to a periodic waveform, but may be a non-periodic waveform. An amplitude of the wobbled track T is selected to be ±10 for example.

### Second Modified Example

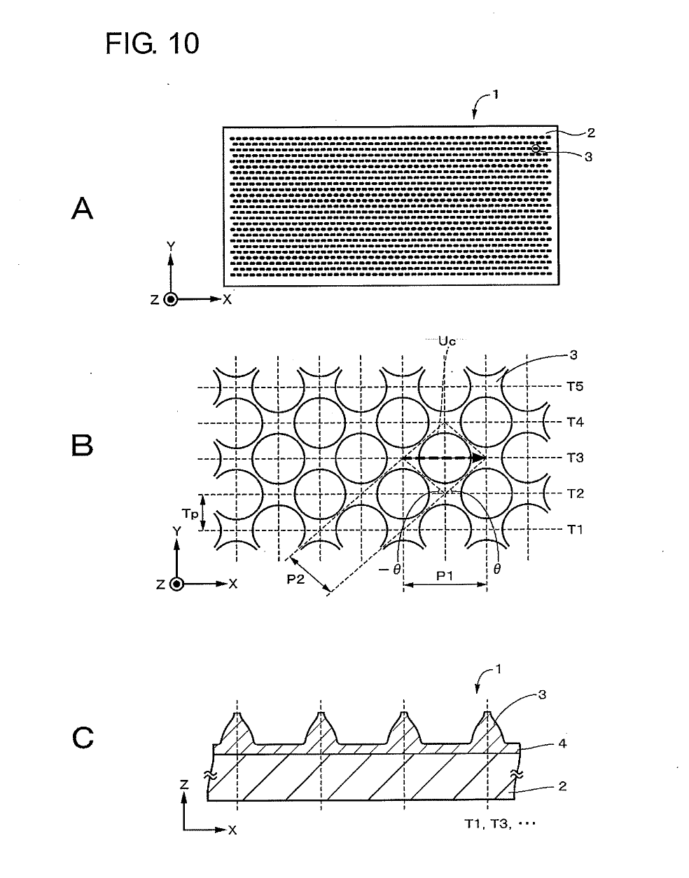

FIG. 10A is a plan view showing an example of a configuration of the optical element according to a second modified example. FIG. 10B is a plan view showing an enlarged portion of the optical element shown in FIG. 10A. FIG. 10C is a cross-sectional view thereof at tracks T1, T3, . . . shown in FIG. 10B. The lower portions of the structures 3 of the tracks T, which are adjacent to each other, may be connected to each other in the ±θ directions. In this manner, it is possible to improve the filling rate of the structures 3 on the surface of the optical element 1. Hence, the antireflection characteristics can be improved.

### Third Modified Example

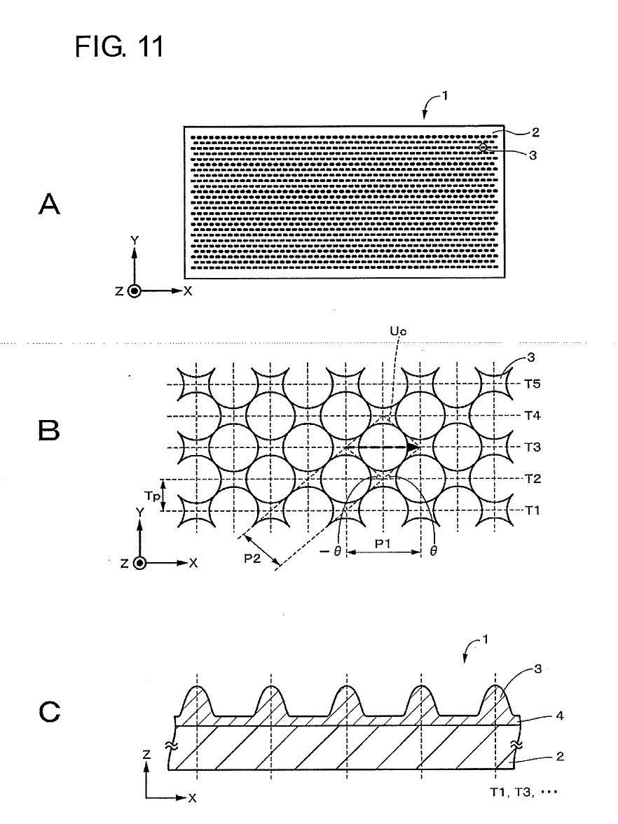

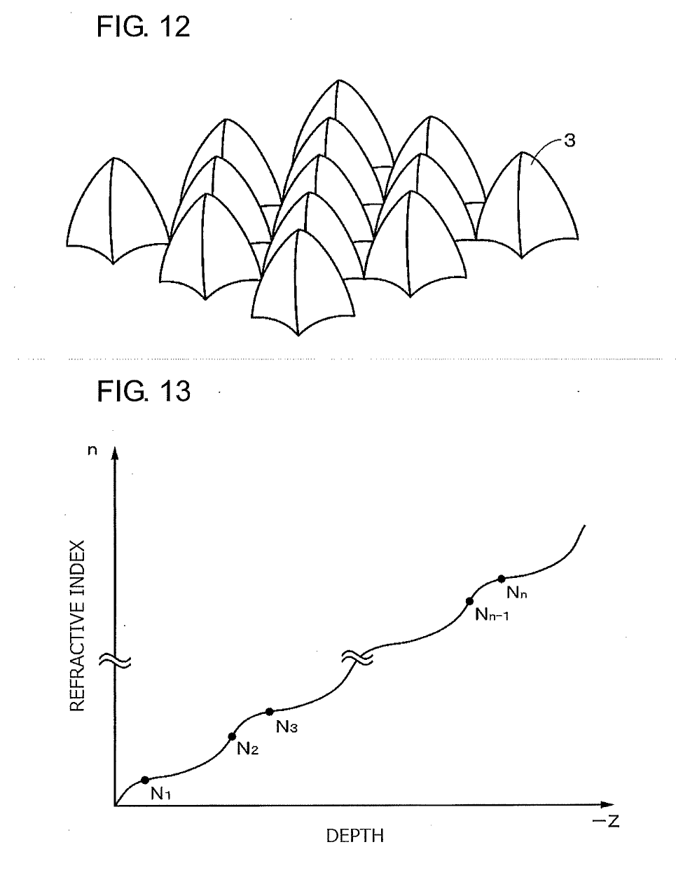

FIG. 11A is a plan view showing an example of a configuration of the optical element according to a third modified example. FIG. 11B is a plan view showing an enlarged portion of the optical element shown in FIG. 11A. FIG. 11C is a cross-sectional view thereof at tracks T1, T3, . . . shown in FIG. 11B. FIG. 12 is a perspective view showing an example of the shape of the structure of the optical element.

The optical element 1 according to the third modified example is different from the first embodiment with respect to a point in which the optical element 1 according to the third modified example has a cone-shape, such as a quadrangular pyramid shape or a truncated quadrangular pyramid shape, which has a gentle slope on a top portion thereof and a slope that gradually gets steeper from a central portion toward a bottom portion thereof. Such a cone-shape can be a parabolic shape or an approximately parabolic shape, for example.

### 2. Second Embodiment

FIG. 13 is a diagram showing an example of a refractive index profile of the optical element according to a second embodiment of the present technique. As shown in FIG. 13, an effective refractive index, with respect to a depth direction of the structures 3 (a −Z-axis direction in FIG. 1), gradually increases and has two or more inflection points N₁, N₂, . . . Nₙ (n: an integer of 2 or more). In this manner, it is possible to reduce reflected light caused by the interference effect of light and to improve the antireflection characteristics of the optical element. It is preferable that a change in the effective refractive index in the depth direction be a monotonic increase. Further, on the top portion side of the structures 3, the change in the effective refractive index in the depth direction is preferably in a state steeper than an average value of the slope of the effective refractive index. Furthermore, the change in the effective refractive index in the depth direction is preferably steep also on the substrate side of the structures 3. In this manner, it is possible to improve transferability while having favorable optical characteristics.

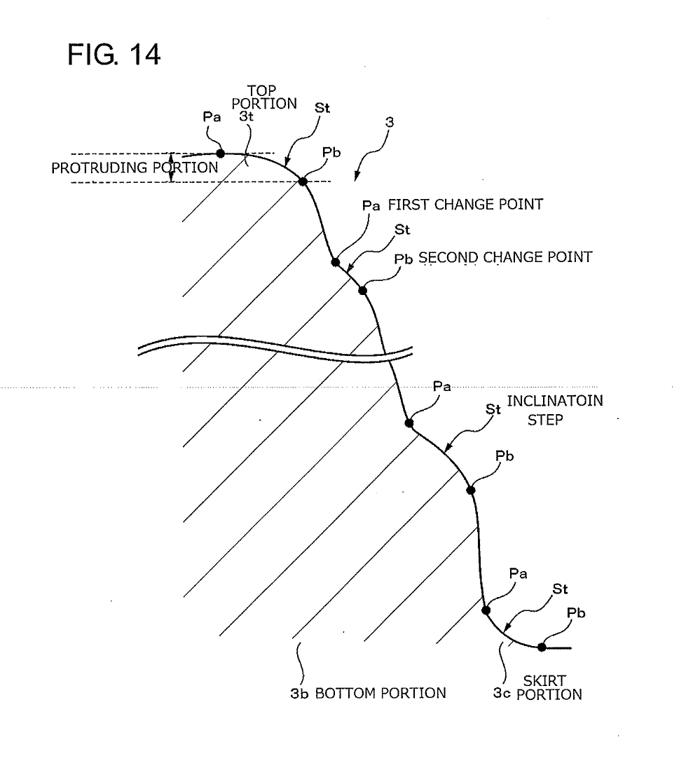

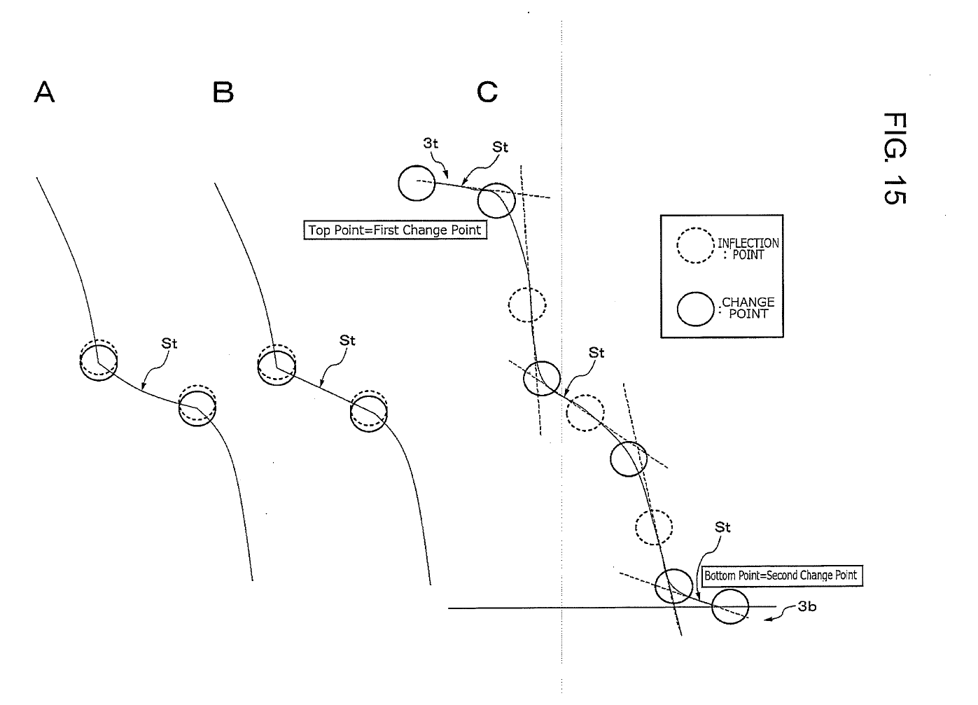

FIG. 14 is a cross-sectional view of an example of the shape of the structure. The structure 3 preferably has a curved surface that gradually widens from a top portion 3t of the structure 3 toward a bottom portion 3b thereof. This is because it is possible to have good transferability with this kind of shape.

The top portion 3t of the structure 3 is a plane surface or a convexly curved surface, for example, and preferably the convexly curved surface. By having the convexly curved surface in this manner, durability of the optical element 1 can be improved. Further, the low refractive index layer, which has a lower refractive index than that of the structure 3, may be formed in the top portion 3t of the structure 3, the formation of the low refractive index layer of this kind can reduce the reflectance.

The curved surface of the structure 3 preferably has two or more pairs of a first change point Pa and a second change point Pb in this order in a direction from the top portion 3t of the structure 3 toward the bottom portion 3b thereof. In this manner, the effective refractive index in the depth direction of the structures 3 (the −Z-axis direction in FIG. 1) can have two or more inflection points. Here, the top portion 3t is also referred to as the first change point Pa and the bottom portion 3b is also referred to as the second change point Pb.

Further, it is preferable that, on a side surface of the structure 3 except the top portion 3t and the bottom portion 3b, one or more pairs of the first change point and second change point be formed in this order in the direction from the top portion 3t of the structure 3 toward the bottom portion 3b thereof. In this case, it is preferable that a slope directed from the top portion 3t of the structure 3 toward the bottom portion 3b become gentler after the first change point Pa and then become steeper after the second change point Pb. Further, as described above, when one or more pairs of the first change point Pa and the second change point Pb are formed in this order, it is preferable that the top portion 3t of the structure 3 be a convexly curved surface or a skirt portion 3c, which spreads while gradually attenuating, be formed on the bottom portion 3b of the structure 3 (refer to FIG. 14).

Here, the first change point and the second change point are defined as below.

As shown in FIGS. 15A and 15B, when a surface between the top portion 3t of the structure 3 and the bottom portion 3b thereof is formed by discontinuously connecting a plurality of smoothly curved surfaces in the direction from the top portion 3t of the structure 3 toward the bottom portion 3b thereof, a connecting point becomes the change point. This change point matches the inflection point. Strictly speaking, differentiation is not possible at the connecting point, but here, such an inflection point, which functions as a limit, is also referred to as an inflection point. When the structure 3 has the above-described curved surface, as shown in FIG. 14, it is preferable that the slope directed from the top portion 3t of the structure 3 toward the bottom portion 3b thereof become gentler after the first change point Pa, and then become steeper after the second change point Pb.

As shown in FIG. 15C, when the surface between the top portion 3t of the structure 3 and the bottom portion 3b thereof is formed by continuously and smoothly connecting the plurality of smoothly curved surfaces in the direction from the top portion 3t of the structure 3 toward the bottom portion 3b thereof, the change point is defined as below. As shown in FIG. 15C, a closest point on a curved line with respect to an intersection point, at which respective tangent lines at the inflection point, a top point, and a bottom point intersect with each other, is referred to as the change point. Further, as described above, the top point becomes the first change point in the top portion 3t, and the bottom point becomes the second change point in the bottom portion 3b.

The structure 3 preferably has two or more inclination steps St on the surface between the top portion 3t of the structure 3 and the bottom portion 3b thereof, and more preferably has two or more and ten or less of the inclination steps St thereon. More specifically, the structure 3 preferably has two or more steps, which include the top portion 3t or the bottom portion 3b, or both of the top portion 3t and the bottom portion 3b, between the top portion 3t and the bottom portion 3b thereof. When there are two or more of the inclination steps St, the effective refractive index with respect to the depth direction of the structure 3 (the −Z-axis direction in FIG. 1) can have two or more inflection points N₁, N₂, . . . Nₙ (n: an integer of 2 or more). Further, when the number of the inclination steps St is 10 or less, the structure 3 can be manufactured easily.

The inclination step St is a step that is not parallel but inclined with respect to the surface of the substrate. By making the inclination step St inclined rather than parallel to the surface of the substrate, favorable transferability can be obtained. Here, the inclination step St is a section that is set by the above-described first change point Pa and second change point Pb. Further, as shown in FIG. 14, the inclination step St is a concept that includes a protruding portion in the top portion 3t and the skirt portion 3c in the bottom portion 3b. More specifically, a section that is set by the first change point Pa and the second change point Pb in the top portion 3t, and a section that is set by the first change point Pa and the second change point Pb in the bottom portion 3b, are also referred to as the inclination step St.

A cross-sectional area of the structure 3 changes with respect to the depth direction of the structure 3 so as to correspond to the above-described refractive index profile. It is preferable that the cross-sectional area of the structure 3 monotonically increase as the cross-sectional area approaches closer to the depth direction of the structure 3. Here, the cross-sectional area of the structure 3 refers to an area of a cut surface that is parallel to the surface of the substrate on which the structures 3 are arranged.

The second embodiment is the same as the first embodiment expect for the above-described points.

### Modified Example

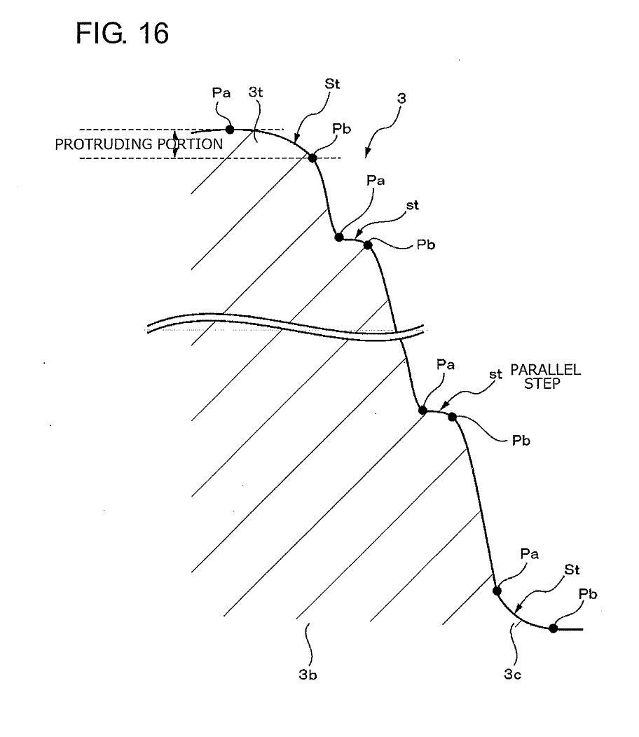

FIG. 16 shows an example of the shape of the structure of the optical element according to a modified example. As shown in FIG. 16, the structure 3 preferably has two or more of at least one of the parallel step st and the inclination steps St on the surface between the top portion 3t of the structure 3 and the bottom portion 3b thereof, and more preferably has two or more and ten or less of at least one of the parallel steps st and the inclination steps St. When the number of the at least one of the parallel steps st and the inclination steps St is two or less, the effective refractive index with respect to the depth direction of the structure 3 (the −Z-axis direction in FIG. 1) can have two or more inflection points. When the number of the at least one of the parallel steps st and the inclination steps St is ten or less, the structure 3 can be manufactured easily.

The parallel step st is a step that is parallel to the surface of the substrate. Here, the parallel step st is a section that is set by the above-described first change point Pa and second change point Pb. Note that the parallel steps st do not include the planar top portion 3t and bottom portion 3b. More specifically, while excluding the top portion 3t and the bottom portion 3b, of the steps formed between the top portion 3t of the structure 3 and the bottom portion 3b thereof, the parallel step is a step that is parallel to the surface of the substrate.

The modified example is the same as the second embodiment except for the above-described points.

### 3. Third Embodiment

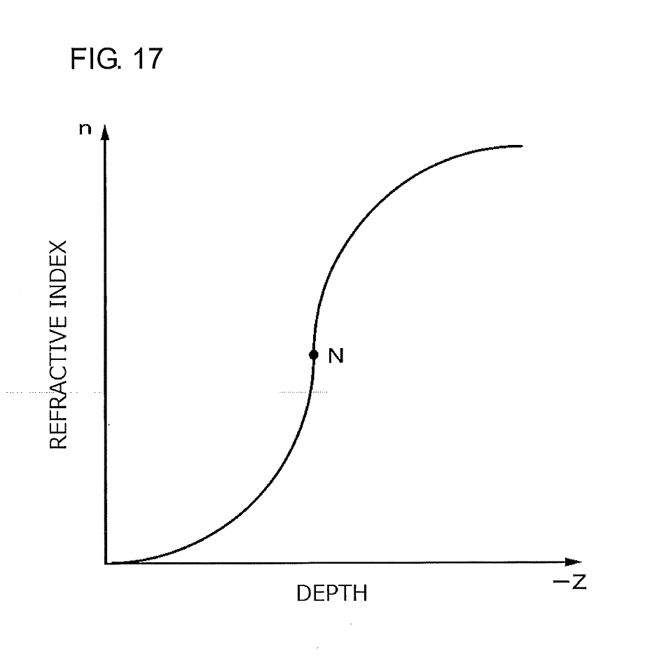

FIG. 17 shows an example of the refractive index profile of the optical element according to a third embodiment of the present technique. As shown in FIG. 17, the effective refractive index with respect to the depth direction of the structure 3 (the −Z-axis direction in FIG. 1) changes so as to form a profile of an S-shaped curved line while gradually increasing toward the substrate 2. More specifically, the refractive index profile has one inflection point N. This inflection point corresponds to a shape of the side surface of the structure 3. As the change of the refractive index profile in this manner can make boundaries unclear for the light, it becomes possible to reduce the reflected light and to improve the antireflection characteristics of the optical element 1. The change of the effective refractive index with respect to the depth direction is preferably a monotonic increase. Here, the S-shape includes an inverse S-shape, namely, Z-shape.

Further, the change of the effective refractive index with respect to the depth direction is preferably steeper than the average value of the slope of the effective refractive index on at least one of the top portion side and the substrate side of the structure 3, and is more preferably steeper than the above-described average value on both the top portion side and the substrate side of the structure 3. In this manner, it is possible to obtain excellent antireflection characteristics.

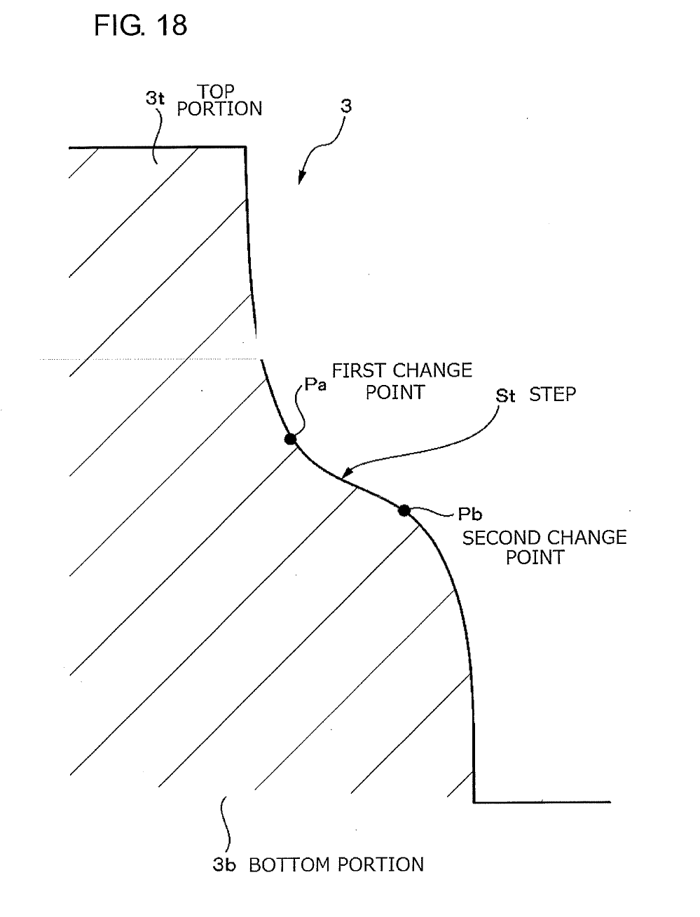

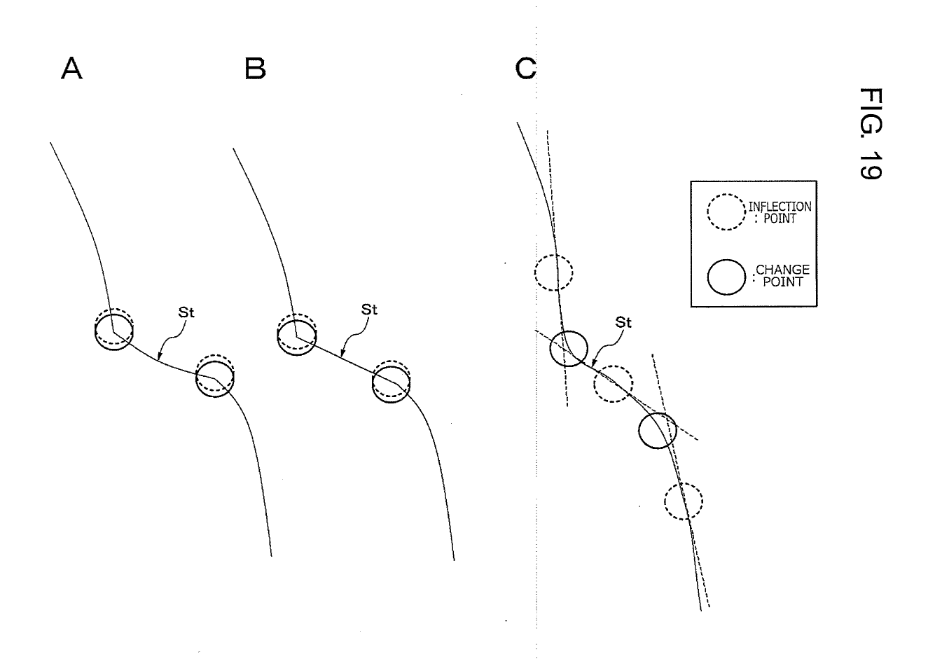

FIG. 18 is an enlarged cross-sectional view showing an example of the shape of the structure. The side surface of the structure 3 preferably changes so as to form a profile of a square root of the S-shaped curved line, which is shown in FIG. 17, while gradually expanding toward the substrate 2. By having such a side surface shape, it is possible to obtain excellent antireflection characteristics and to improve the transferability of the structure 3.

The top portion 3t of the structure 3 is formed in a planar shape or in a convex shape that tapers toward a tip thereof. When the top portion 3t of the structure 3 is formed in the planar shape, it is preferable that an area ratio (St/S), which is a ratio of an area St of a planar surface of the top portion of the structure with respect to the unit lattice area S, become smaller as the height of the structure 3 becomes higher. By doing so, it is possible to improve the antireflection characteristics of the optical element 1. Here, the unit lattice is a tetragonal lattice pattern, a quasi-tetragonal lattice, etc., for example. It is preferable that an area ratio of the bottom surface of the structure (an area ratio (Sb/S) of an area Sb of the bottom surface of the structure with respect to the unit lattice area S) be close to the area ratio of the top portion 3t. Further, the low refractive index layer that has a lower refractive index than that of the structure 3 may be formed in the top portion 3t of the structure 3, and the formation of such a low refractive index layer can lower the reflectance.

The side surface of the structure 3 except the top portion 3t and the bottom portion 3b preferably has one of the pair of the first change point Pa and the second change point Pb in this order in the direction from the top portion 3t toward the bottom portion 3b of the structure 3. In this manner, the effective refractive index with respect to the depth direction of the structure 3 (the −Z-axis direction in FIG. 1) can have one inflection point.

Here, the first change point and the second change point are defined as below.

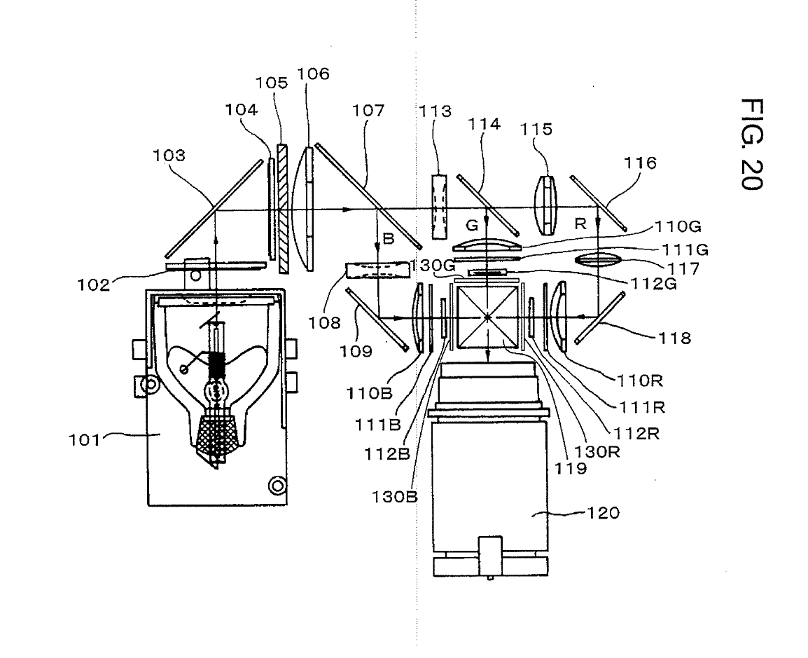

As shown in FIGS. 19A and 19B, when the side surface between the top portion 3t of the structure 3 and the bottom portion 3b thereof is formed by discontinuously connecting the plurality of smoothly curved surfaces in the direction from the top portion 3t of the structure 3 toward the bottom portion 3b thereof, the connecting point becomes the change point. This change point matches the inflection point. Strictly speaking, differentiation is not possible at the connecting point, but here, such an inflection point, which functions as a limit, is also referred to as an inflection point. When the structure 3 has the above-described curved surface, it is preferable that the slope, which is directed from the top portion 3t of the structure 3 toward the bottom portion 3b thereof, become gentler after the first change point Pa, and then become steeper after the second change point Pb.

As shown in FIG. 19C, when the side surface between the top portion 3t of the structure 3 and the bottom portion 3b thereof is formed by continuously and smoothly connecting the plurality of smoothly curved surfaces in the direction from the top portion 3t of the structure 3 toward the bottom portion 3b thereof, the change point is defined as below. As shown in FIG. 19C, a closest point on a curved line with respect to an intersection point at which respective tangent lines at two inflection points intersect with each other is referred to as the change point, wherein the two inflection points are present on the side surface of the structure.

The structure 3 preferably has one of the steps St on the side surface positioned between the top portion 3t and the bottom portion 3b. By having one step St in this manner, it is possible to realize the above-described refractive index profile. More specifically, it is possible to change the effective reflective index with respect to the depth direction of the structure 3 so as to form the profile of the S-shaped curved line while gradually increasing the effective reflective index toward the substrate 2. The step can be the inclination step or the parallel step, for example, and the inclination step is preferable. By having the inclination step as the step St, instead of the parallel step, it is possible to obtain favorable transferability.

The inclination step is a step that is not parallel to the surface of the substrate, and a side surface of which is inclined so as to gradually expand in the direction from the top portion 3t of the structure 3 toward the bottom portion 3b thereof. The parallel step is a step that is parallel to the surface of the substrate. Here, the step St is a section that is set by the above-described first change point Pa and second change point Pb. Note that the steps St do not include the planar surface of the top portion 3t and a curved surface or a planar surface between the structures.

The cross-sectional area of the structure 3 changes with respect to the depth direction of the structure 3 so as to correspond to the above-described refractive index profile. It is preferable that the cross-sectional area of the structure 3 monotonically increase toward the depth direction of the structure 3. Here, the cross-sectional area refers to an area of a cut surface that is parallel to the surface of the substrate on which the structures 3 are arranged. It is preferable that the cross-sectional area of the structure be changed in the depth direction so that ratios of the cross-sectional area of the structure 3 at positions with different depths correspond to the above-described effective refractive index profile corresponding to the positions.

The third embodiment is the same as the first embodiment except for the above-described points.

### Fourth Embodiment

FIG. 20 is a schematic diagram showing a configuration of a projection apparatus according to a fourth embodiment of the present technique. As shown in FIG. 20, the projection apparatus (a projection image display apparatus) is configured to include a light source 101, a micro lens array 102, a mirror 103, a micro lens array 104, a PS converter 105, a condenser lens 106, a dichroic mirror 107, a condenser lens 108, a mirror 109, a condenser lens 113, a dichroic mirror 114, a relay lens 115, a mirror 116, a relay lens 117, a mirror 118, condenser lenses 110B, 110G, and 110R, polarizers 111B, 111G, and 111R, liquid crystal panels (liquid crystal elements) 112B, 112G, and 112R, polarizers 130B, 130G, and 130R, a cross beam combiner prism 119, and a projection lens 120.

The light source 101 is an extra-high pressure mercury lamp, for example, and emits white light onto the mirror 103. The white light emitted from the light source 101 is transmitted through the micro lens array 102, reflected by the mirror 103, and then guided to the micro lens array 104. The white light guided to the micro lens array 104 is transmitted through the micro lens array 104, converted into a polarization wave (a P polarization wave, for example) of a predetermined polarization direction in the PC converter 105, and then guided to the dichroic mirror 107 via the condenser lens 106.

Then, of the white light guided to the dichroic mirror 107, only light having a blue color component is reflected by the dichroic mirror 107 and is guided to the mirror 109 via the condenser lens 108. The blue light guided to the mirror 109 is reflected by the mirror 109 and is guided to the cross beam combiner prism 119 via the condenser lens 110B, the polarizer 111B, the liquid crystal panel 112B, and the polarizer 130B. Meanwhile, light having green and red color components is transmitted through the dichroic mirror 107 and enters the dichroic mirror 114 via the condenser lens 113.

Of the light that enters the dichroic mirror 114, only light having the green color component is reflected by the dichroic mirror 114 and is guided to the cross beam combiner prism 119 via the condenser lens 110G, the polarizer 111G, the liquid crystal panel 112G, and the polarizer 130G. Meanwhile, light having the red color component is transmitted through the dichroic mirror 114 and enters the mirror 116 via the relay lens 115.

The red light that enters the mirror 116 is reflected by the mirror 116 and is guided to the mirror 118 via the relay lens 117. The light guided by the mirror 118 is reflected by the mirror 118 and is guided to the cross beam combiner prism 119 via the condenser lens 110R, the polarizer 111R, the liquid crystal panel 112R, and the polarizer 130R.

Then, the light of the respective colors, which is guided to the cross beam combiner prism 119, is combined at the cross beam combiner prism 119 and is projected onto a screen (not shown in the figures) via the projection lens 120.

The optical element 1 having an antireflection function is provided on a surface of at least one of a plurality of optical components that are arranged on an optical path of the light emitted from the light source 101. The optical element 1 according to one of the above-described first to third embodiments and the modified examples thereof is used as the optical element 1. The optical element 1 is provided on at least one of a light incidence surface and a light emission surface of the optical component.

More specifically, the optical element 1 is provided on a surface of one or more optical components that are selected from a group consisting of the micro lens array 102, the mirror 103, the micro lens array 104, the PS converter 105, the condenser lens 106, the dichroic mirror 107, the condenser lens 108, the mirror 109, the condenser lens 113, the dichroic mirror 114, the relay lens 115, the mirror 116, the relay lens 117, the mirror 118, the condenser lenses 110B, 110G, and 110R, the polarizers 111B, 111G, and 111R, the liquid crystal panels 112B, 112G, and 112R, the polarizers 130B, 130G, and 130R, the cross beam combiner prism 119, and the projection lens 120. Here, the surface of the optical component refers to at least one of an incidence surface, into which the light emitted from the light source 101 enters, and an emission surface, from which the light entered from the incidence surface exits.

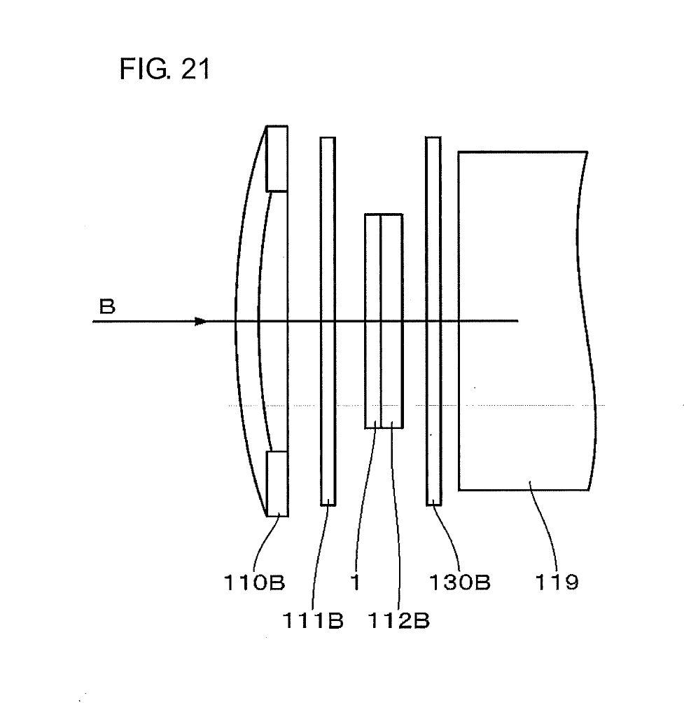

FIG. 21 is a schematic diagram showing an enlarged view of the liquid crystal panel 112B shown in FIG. 20 and an area adjacent thereto. As shown in FIG. 21, the optical element 1 is provided on an incidence surface of the liquid crystal panel 112B. Note that the optical element 1 may be provided on incidence surfaces of the liquid crystal panels 112G and 112R in the same manner.

When the optical element 1 is provided to the optical component of the projection apparatus in this manner, from the viewpoint of improving light resistance, it is preferable to use a glass substrate, which is a heat-resistant substrate, as the substrate 2 of the optical element 1. Light-resistant organic material is preferably used as a primary component of the transfer material 18 that forms the structures 3 of the optical element. As the light-resistant organic material, it is preferable to use an ultraviolet ray-curable resin, the absorptance of which after being cured falls within the range indicated in the above-described first embodiment.

According to the fourth embodiment, when the optical element 1 having the antireflection function is provided on the incidence surface of the optical component of the projection apparatus, it is possible to prevent reflection of light on the incidence surface of the optical component. Therefore, it is possible to reduce power consumption of the projection apparatus.

Further, when the optical element 1 is provided on the emission surface of the optical component of the projection apparatus, it is possible to improve transmission of light on the emission surface of the optical component. Therefore, it is possible to reduce the power consumption of the projection apparatus.

### EXAMPLES

Although the present technique will be described more specifically below using examples, the present technique is not limited to only those examples.

The examples will be described in the following order.

1. Comparison of reflectance spectra between a convex structure and a concave structure
2. Relationship between light absorptance and light resistance of transfer materials

### 1. Comparison of Reflectance Spectra Between a Convex Structure and a Concave Structure

### Example 1-1

First, a glass roll master having an outer diameter of 126 mm was prepared and a resist was deposited on a surface of the glass roll master in the following manner. More specifically, a photoresist was diluted by a thinner to a 1/10 dilution, and the diluted resist was applied onto a cylindrical surface of the glass roll master through dipping so that the resist coating has an approximately 130 nm thickness, whereby the resist is deposited. Next, the glass master serving as a recording medium was conveyed to the roll master exposure apparatus shown in FIG. 5, and the resist was exposed to light so that latent images which were continuously formed in a spiral-shape and form tetragonal lattice patterns between three rows of tracks that were adjacent to one another were patterned on the resist.

More specifically, concave-shaped tetragonal lattice patterns were formed by irradiating a laser beam having a power of 0.50 mW/m, which caused the glass roll master to be exposed up to the surface thereof, onto an area on which the tetragonal lattice patterns were to be formed. Note that a thickness of the resist in the row direction of track rows was approximately 120 nm, and a thickness of the resist in the extending direction of the tracks was approximately 100 nm.

Next, the resist arranged on the glass roll master was subjected to development processing, so that development was performed by solving the resist of an exposed portion. More specifically, the glass master, which had not yet been developed, was placed on a turntable of a not-shown developing machine, and the liquid developer was dropped to the surface of the glass roll master while rotating together with the turntable to develop the resist on the surface thereof. In this manner, a resist glass master was obtained in which the resist was open in the tetragonal lattice pattern.

Next, a quadrangular pyramid-shaped structure, which had a convex shape, was manufactured through dry etching by alternately performing etching processing and ashing processing. Four sides, which formed a quadrangular bottom surface of the structure, were curved in an arc-shape toward a center of the quadrangular shape. Note that such a shape of the structure was formed by adjusting a processing time of the etching processing and the ashing processing in a glass roll master manufacturing process. Lastly, by completely removing the photoresist by O₂ ashing, a motheye glass roll master, which has a convex tetragonal lattice pattern, was obtained.

Next, after an ultraviolet ray-curable resin composition was applied to a PET film, the motheye glass roll master was brought into close contact with the coated surface and then was removed therefrom while being cured by being irradiated with an ultraviolet ray of a metal halide lamp. As a result, a film master was manufactured in which many concave-shaped structures were provided on a surface of the PET film in a tetragonal lattice pattern.

Next, after the ultraviolet ray-curable resin composition was applied to a quartz substrate, which was a heat-resistant substrate, the film master was brought into close contact with the coated surface and then removed therefrom while being cured by being irradiated with an ultraviolet ray. Ad a result, an optical element was manufactured in which many convex-shaped structures were provided on a surface of the quartz substrate in a tetragonal lattice pattern.

Next, the surface of the manufactured optical element was observed using an Atomic Force Microscope (AFM). Next, pitches and a height of the structure were calculated on the basis of a cross-sectional profile of the AFM. Further, an aspect ratio was calculated on the basis of those pitches and height. Those results are shown in Table 1.

### Example 1-2

An optical element was obtained in the same manner as that in Example 1-1 except that the structures, which each had a configuration shown in Table 1, were formed on the surface of a quartz substrate by adjusting the exposure process and the etching process.

### Example 1-3

An optical element was obtained in the same manner as that in Example 1-1 except that the structures, which each had a configuration shown in Table 1, were formed on the surface of a quartz substrate by adjusting the exposure process and the etching process.

### Comparative Example 1-1

An optical element was obtained in the same manner as that in Example 1-1 except that the structures, which each had a configuration shown in Table 1, were formed on the surface of a quartz substrate by adjusting the exposure process and the etching process.

### Comparative Example 1-2

An optical element was obtained in the same manner as that in Example 1-1 except that the structures, which each had a configuration shown in Table 1, were formed on the surface of a quartz substrate by adjusting the exposure process and the etching process.

### (Reflectance)

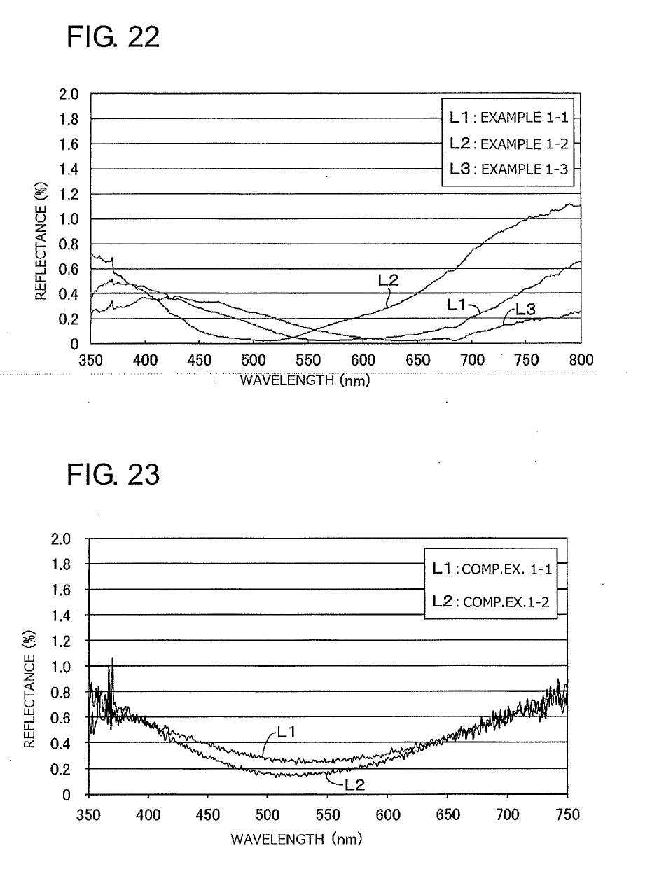

First, a black tape was stuck to a back surface side (an opposite side to a side on which the structures were formed) of the optical element, which was obtained in the above-described manner, whereby processing was performed that filtered out reflection from the back surface of the optical element. Next, the reflectance spectrum was measured using an ultraviolet-visible light spectrophotometer (manufactured by JASCO Corporation; product name: V-500). A regular reflection 5° unit was used at a time of the measurement. Those results are shown in FIG. 22 and FIG. 23.

Table 1 shows the configurations of the optical elements according to Examples 1-1 to 1-3 and Comparative Examples 1-1 and 1-2.

TABLE 1

| | Circumferential | Feed Pitch | Pitch | | | | |
|---|---|---|---|---|---|---|---|
| | Pitch | (Pitch P2) | (Pitch Tp) | Height | Aspect | | |
| | (Pitch P1) [nm] | [nm] | [nm] | [nm] | Ratio | Shape | Arrangement |
| Example 1-1 | 340 | 170 | 240 | 222 | 0.92 | Convex | Tetragonal |
| | | | | | | | Lattice |
| Example 1-2 | 366 | 170 | 250 | 185 | 0.74 | Convex | Quasi- |
| | | | | | | | Tetragonal |
| | | | | | | | Lattice |
| Example 1-3 | 280 | 140 | 198 | 276 | 1.39 | Convex + S | Tetragonal |
| | | | | | | | Lattice |
| Comparative | 340 | 170 | 240 | 211 | 0.88 | Concave | Tetragonal |
| Example 1-1 | | | | | | | Lattice |
| Comparative | 366 | 170 | 250 | 180 | 0.72 | Concave | Quasi- |
| Example 1-2 | | | | | | | Tetragonal |
| | | | | | | | Lattice |

Note
that “convex” and “concave” shapes in Table 1 mean that the shape of the structure is convex-shaped and it is concave-shaped, respectively. Further, a “convex + S” shape means that the shape of the structure is convex-shaped and the effective refractive index in the depth direction of the structure changes so as to form a profile of an S-shaped curved line while gradually increasing toward the substrate.

The following is revealed from the above-described evaluation results.

In Examples 1-1 to 1-3 in which the structure was formed in the convex shape, it is possible to suppress the reflectance over the almost entire wavelength range of 350 nm or larger and 750 nm or lower when compared with Comparative Examples 1-1 and 1-2 in which the structure was formed in the concave shape.

Further, in Examples 1-1 to 1-3 in which the structure was formed in the convex shape, it is possible to lower a minimum value of the reflectance when compared with Comparative Examples 1-1 and 1-2 in which the structure was formed in the concave shape.

Therefore, from the viewpoint of improving the antireflection characteristics, it is preferable to form the shape of the structure in the convex shape.

### 2. Relationship Between Light Absorptance and Light Resistance of Transfer Materials

In this Example, the absorptance indicates an absorptance of the cured ultraviolet ray-curable resin composition (the transfer material) with respect to light having a wavelength of 424 nm or higher and 750 nm or lower.

### Example 2-1

An optical element 1 was obtained in the same manner as that in Example 1-1 except that the ultraviolet ray-curable resin composition having an absorptance of 2.0% was used as the transfer material.

### Example 2-2

An optical element 1 was obtained in the same manner as that in Example 1-1 except that the ultraviolet ray-curable resin composition having an absorptance of 1.2% was used as the transfer material.

### Example 2-3

An optical element 1 was obtained in the same manner as that in Example 1-1 except that the ultraviolet ray-curable resin composition having an absorptance of 2.35% was used as the transfer material.

### Example 2-4

An optical element 1 was obtained in the same manner as that in Example 1-1 except that the ultraviolet ray-curable resin composition having an absorptance of 7.9% was used as the transfer material.

### Example 2-5

An optical element 1 was obtained in the same manner as that in Example 1-1 except that the ultraviolet ray-curable resin composition having an absorptance of 5.7% was used as the transfer material.

### (Acceleration Test for Light-Resistance)

An acceleration test for light-resistance was conducted by condensing a blue-violet laser beam via a collimator lens onto the surface on the structure side of the optical element, which was obtained in the above-described manner.

Conditions of the acceleration test for light-resistance are shown below.

Blue-violet laser: manufactured by Nichia Corporation; model number NDV4A14T; wavelength 424 nm, θ // 9.6°, θ ⊥ 22.7°

Collimator lens: focal distance 20 mm; condenser lens focal distance 100 mm

Condensed beam: condensed beam diameter φ 11 mm×25 mm; power 54 mW

Next, after the acceleration test for light-resistance was conducted on the optical element, the optical element was evaluated on the basis of the following criteria. Those results are shown in Table 2.

AA: No change for 500 hours

A: No change for 200 hours

B: Yellowing at 200 hours

C: Burned brown at 100 hours

### (Transmittance)

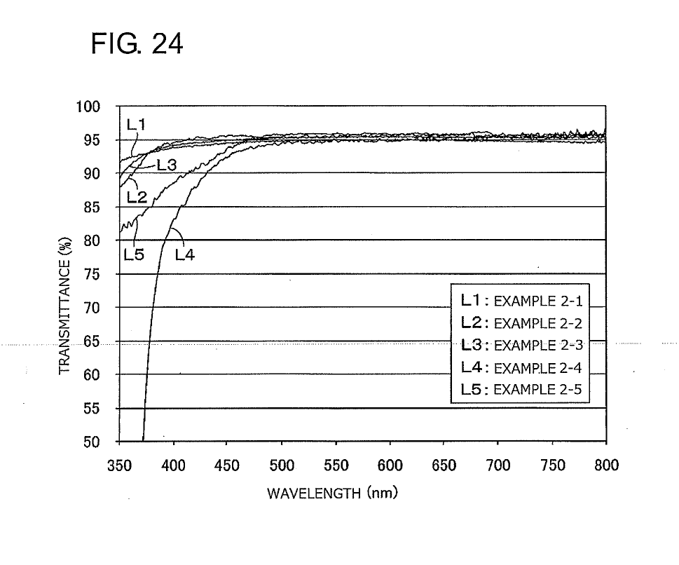

The transmission spectrum was measured by using the ultraviolet-visible light spectrophotometer (manufactured by JASCO Corporation; product name: V-500). Those results are shown in FIG. 24.

Table 2 shows the configurations of the optical elements according to Examples 2-1 to 2-5.

TABLE 2

| | Absorptance (%) | Test Result |
|---|---|---|
| Example 2-1 | 2.00 | A |
| Example 2-2 | 1.20 | AA |
| Example 2-3 | 2.35 | A |
| Example 2-4 | 7.90 | C |
| Example 2-5 | 5.70 | B |

From Table 2, it is understood that the light resistance is good in Examples 2-1 to 2-3, whereas the light resistance decreases in Examples 2-4 and 2-5.

As clear from FIG. 24, it is understood that decrease in the transmittance with respect to light having a short wavelength of approximately 450 nm or more is suppressed in Examples 2-1 and 2-3, whereas the transmittance with respect to light having the short wavelength of approximately 450 nm or less decreases significantly in Examples 2-4 and 2-5. It is considered that the light resistance decreases in Examples 2-4 and 2-5 as described above because the transmittance with respect to light having the short wavelength of approximately 450 nm or less decreases significantly, in other words, because the absorptance, with respect to light having the short wavelength of approximately 450 nm or less, is high.

Based on the foregoing, from the viewpoint of the light resistance, the absorptance of the structure (more specifically, the cured ultraviolet ray-curable resin composition), with respect to the light having the wavelength of 424 nm or more and 750 nm or less, is preferably 4% or less, more preferably 2.35% or less, and even more preferably 1.2% or less.

Although the embodiments of the present technique have been described above in detail, the present technique is not limited to the above-described embodiments, and various modifications based on the technical concept of the present technique can be made thereto.

For example, configurations, methods, processes, shapes, materials, values, etc., which are mentioned in the above-described embodiments, are all merely examples, and different configurations, methods, processes, shapes, materials, values, etc. from those mentioned above may be used as necessary.

Further, the configurations, the methods, the processes, the shapes, the materials, the values, etc. of the above-described embodiments can be combined with one another without departing from the spirit of the present technique.

Further, the following configurations can be adopted for the present technique.

(1)

An optical element having an antireflection function, comprising:

a substrate; and

structures that each are formed of a convex portion and that are arranged in plural on a surface of the substrate at a fine pitch equal to or less than a wavelength of light, wherein

each of the structures has any of a quadrangular pyramid shape and a truncated quadrangular pyramid shape that each have a quadrangular bottom surface, and

each of four sides that form the quadrangular bottom surface is curved toward a center of the bottom surface.

(2)

The optical element according to (1), wherein an absorptance of the structure with respect to light having a wavelength of 424 nm or more is 4% or less.

(3)

The optical element according to (1), wherein an absorptance of the structure with respect to light having a wavelength of 424 nm or more is 2.35% or less.

(4)

The optical element according to (1), wherein an absorptance of the structure with respect to light having a wavelength of 424 nm or more is 1.2% or less.

(5)

The optical element according to any one of (1) to (4), wherein the structure has any of the quadrangular pyramid shape and the truncated quadrangular pyramid shape that each have a gentle slope in a top portion thereof and a slope that gradually becomes steeper from a central portion to a bottom portion thereof.

(6)

The optical element according to any one of (1) to (4), wherein an effective refractive index in a depth direction of the structure gradually increases toward the substrate and also forms a profile of an S-shaped curved line.

(7)

The optical element according to any one of (1) to (6), wherein each of the curved four sides has any of an arc-shape, an approximately arc-shape, an elliptic arc-shape, and an approximately elliptic arc-shape.

(8)

The optical element according to any one of (1) to (7), wherein the structures form any of a tetragonal lattice pattern and a quasi-tetragonal lattice pattern on the surface of the substrate.

(9)

The optical element according to any one of (1) to (8), wherein

the plurality of structures are arranged so as to form a plurality of rows of tracks on the surface of the substrate, and

one of a height and a depth of the structures in one of 45° and approximately 45° directions with respect to the tracks is smaller than corresponding one of the height and the depth in another direction.

(10)

The optical element according to any one of (1) to (9), wherein

the plurality of structures are arranged so as to form a plurality of rows of tracks on the surface of the substrate, and

the tracks meander.

The optical element according to any one of (1) to (10), wherein

the substrate is a quartz substrate, and

the structures includes an ultraviolet ray-curable resin as a primary component thereof.

(12)

A manufacturing method of an optical element that has an antireflection function, the method including: transferring a shape of a film master to an organic resin material to form structures that each are formed of a convex portion and that are arranged in plural on a surface of a substrate at a fine pitch equal to or less than a wavelength of light, wherein

each of the structures has any of a quadrangular pyramid shape and a truncated quadrangular pyramid shape that each have a quadrangular bottom surface, and

each of four sides that form the quadrangular bottom surface is curved toward a center of the bottom surface.

(13)

The manufacturing method of an optical element according to (12), further including cutting out the substrate into a predetermined size after forming the structures on the surface of the substrate.

(14)

A display element that is provided with the optical element according to any one of (1) to (11).

(15)

A projection image display apparatus that is provided with the optical element according to any one of (1) to (11).

### REFERENCE SIGNS LIST

1 optical element
2, 42 substrate
3, 12, 43 structures
4 basal layer
11 roll master
13 resist layer
14 laser light
15 latent image
16, 18 transfer material
17, 19 energy ray source
41 film master

1. An optical element having an antireflection function, comprising:
a substrate; and
structures that each are formed of a convex portion and that are arranged in plural on a surface of the substrate at a fine pitch equal to or less than a wavelength of light, wherein
each of the structures has any of a quadrangular pyramid shape and a truncated quadrangular pyramid shape that each have a quadrangular bottom surface, and
each of four sides that form the quadrangular bottom surface is curved toward a center of the bottom surface.

2. The optical element according to claim 1, wherein
an absorptance of the structure with respect to light having a wavelength of 424 nm or more is 4% or less.

3. The optical element according to claim 1, wherein
an absorptance of the structure with respect to light having a wavelength of 424 nm or more is 2.35% or less.

4. The optical element according to claim 1, wherein
an absorptance of the structure with respect to light having a wavelength of 424 nm or more is 1.2% or less.

5. The optical element according to claim 1, wherein
the structure has any of the quadrangular pyramid shape and the truncated quadrangular pyramid shape that each have a gentle slope in a top portion thereof and a slope that gradually becomes steeper from a central portion to a bottom portion thereof.

6. The optical element according to claim 1, wherein an
effective refractive index in a depth direction of the structure gradually increases toward the substrate and also forms a profile of an S-shaped curved line.

7. The optical element according to claim 1, wherein
each of the curved four sides has any of an arc-shape, an approximately arc-shape, an elliptic arc-shape, and an approximately elliptic arc-shape.

8. The optical element according to claim 1, wherein
the structures form any of a tetragonal lattice pattern and a quasi-tetragonal lattice pattern on the surface of the substrate.

9. The optical element according to claim 1, wherein
the plurality of structures are arranged so as to form a plurality of rows of tracks on the surface of the substrate, and
one of a height and a depth of the structures in one of 45° and approximately 45° directions with respect to the tracks is smaller than corresponding one of the height and the depth in another direction.

10. The optical element according to claim 1, wherein
the plurality of structures are arranged so as to form a plurality of rows of tracks on the surface of the substrate, and
the tracks meander.

11. The optical element according to claim 1, wherein
the substrate is a quartz substrate, and
the structures includes an ultraviolet ray-curable resin as a primary component thereof.

12. A manufacturing method of an optical element that has an antireflection function, the method comprising:
transferring a shape of a film master to an organic resin material to form structures that each are formed of a convex portion and that are arranged in plural on a surface of a substrate at a fine pitch equal to or less than a wavelength of light, wherein
each of the structures has any of a quadrangular pyramid shape and a truncated quadrangular pyramid shape that each have a quadrangular bottom surface, and
each of four sides that form the quadrangular bottom surface is curved toward a center of the bottom surface.

13. The manufacturing method of an optical element according to claim 12, further comprising cutting out the substrate into a predetermined size after forming the structures on the surface of the substrate.

14. A display element that is provided with the optical element according to claim 1.

15. A projection image display apparatus that is provided with the optical element according to claim 1.
